(19) United States
(12) Patent Application Publication
(10) Pub. No.: US 2026/0254655 A1
(43) Pub. Date: Aug. 27, 2026

(54) INFORMATION PROCESSING METHOD AND APPARATUS, COMMUNICATION DEVICE, AND STORAGE MEDIUM

(71) Applicant: Beijing Xiaomi Mobile Software Co., Ltd, Beijing (CN)

(72) Inventors: Haoran LIANG, Beijing (CN); Wei LU, Beijing (CN)

(21) Appl. No.: 18/857,739

(22) PCT Filed: Apr. 19, 2022
(86) PCT No.: PCT/CN2022/087778

§ 371 Date: Oct. 17, 2024

(51) Int. Cl. H04L 9/32; H04L 9/08

(52) U.S. Cl. CPC H04L 9/3242; H04L 9/0869; H04L 9/3247

(57) ABSTRACT

An information processing method is performed by a Personal IoT Network Element (PINE), and includes: sending a first request for applying for an operator credential to a Personal IoT Network (PIN) Element with Gateway Capability (PEGC) based on a preconfigured operator public key; receiving a first response returned based on the first request; and obtaining the operator credential carried in the first response based on the operator public key.

### CROSS REFERENCE TO RELATED APPLICATION

The present application is a U.S. National Stage of International Application No. PCT/CN2022/087778, filed on Apr. 19, 2022, the content of which is incorporated herein by reference in its entirety.

### TECHNICAL FIELD

The present disclosure relates to, but is not limited to, the field of wireless communication technologies, and in particular to an information processing method and apparatus, a communication device and a storage medium.

### BACKGROUND

There are types of Internet of Things (IOT) devices to meet different application requirements.

Based on the greatly increasing number of IoT devices, users mainly create (e.g., plan, change topology) networks using all these IoT devices at home, in the office, in factories, and/or around their bodies. A Personal IoT Network (PIN) may include various devices that users frequently use.

Personal IoT Network Element (PINE) is not able to directly access the fifth-generation mobile communication system (5^{th} Generation System, 5GS), while 5GS needs to further authenticate the PINE to achieve enhanced management of PINE. To meet this requirement, 5GS needs to provision an operator credential for the PINE. However, in related art, for PIN scenarios, there is still a lack of a technology to enable securely configuring of an operator credential.

### SUMMARY

Embodiments of the present disclosure provide an information processing method and apparatus, a communication device, and a storage medium.

A first aspect of an embodiment of the present disclosure provides an information processing method. The method is performed by a PINE, and the method includes:
sending a first request for applying for an operator credential to a PIN Element with Gateway Capability (PEGC) based on a preconfigured operator public key;
receiving a first response returned based on the first request; and obtaining the operator credential carried in the first response based on the operator public key.

A second aspect of an embodiment of the present disclosure provides an information processing method. The method is performed by a PIN Element with Gateway Capability (PEGC), and the method includes:
receiving a first request sent by a PINE based on a preconfigured operator public key, wherein the first request is used for applying for an operator credential;
sending a second request to a first network element according to the first request;
receiving a second response returned by the first network element based on the second request; and
sending a first response to the PINE according to the second response.

A third aspect of an embodiment of the present disclosure provides an information processing method. The method is performed by a first network element, and the method includes:
receiving a second request sent by a PEGC, wherein the second request is sent based on a first request, and the first request is a request which is sent by a PINE based on a preconfigured operator public key and is used for applying for an operator credential;
sending a third request to the second network element according to the second request;
receiving a third response returned based on the third request; and sending a second response to the PEGC according to the third response.

A fourth aspect of an embodiment of the present disclosure provides an information processing method. The method is performed by a second network element, and the method includes:
receiving a third request;
determining whether to configure an operator credential for a PINE based on a result of processing the third request using an operator private key;
when it is determined to configure the operator credential for the PINE, sending a fourth request to a third network element;
receiving the operator credential returned based on the fourth request;
performing security processing on the operator credential using the operator private key to obtain the operator credential after security processing; and
sending a third response to a first network element by carrying the operator credential after security processing in the third response.

A fifth aspect of an embodiment of the present disclosure provides an information processing method. The method is performed by a third network element, and the method further includes:
receiving a fourth request from a second network element;
configuring an operator credential for a PINE according to the fourth request, wherein the PINE is a device that is not configured with a default credential and is preconfigured with an operator public key; and
sending a fourth response to the second network element by carrying the operator credential in the fourth response, wherein the operator credential is used to be issued to the PINE after security processing with an operator private key corresponding to the operator public key.

A sixth aspect of an embodiment of the present disclosure provides an information processing apparatus, including:
a first sending module configured to send a first request for applying for an operator credential to a PIN Element with Gateway Capability (PEGC) based on a preconfigured operator public key;
a first receiving module configured to receive a first response returned based on the first request; and
a first obtaining module configured to obtain the operator credential carried in the first response based on the operator public key.

A seventh aspect of an embodiment of the present disclosure provides an information processing apparatus. The information processing apparatus includes:
a second receiving module configured to receive a first request which is sent by a PINE based on a preconfigured operator public key, wherein the first request is used for applying for an operator credential;
a second sending module configured to send a second request to a first network element according to the first request;
wherein the second receiving module is further configured to receive a second response which is returned by the first network element based on the second request;
wherein the second sending module is further configured to send a first response to the PINE according to the second response.

An eighth aspect of an embodiment of the present disclosure provides an information processing apparatus, including:
a third receiving module configured to receive a second request sent by a PEGC, wherein the second request is sent based on the first request, wherein the first request is a request which is sent by a PINE based on a preconfigured operator public key and is used for applying for an operator credential;
a third sending module configured to send a third request to a second network element according to the second request;
wherein the third receiving module is configured to receive a third response returned based on the third request;
wherein the third sending module is configured to send a second response to the PEGC according to the third response.

A ninth aspect of an embodiment of the present disclosure provides an information processing apparatus. The apparatus includes: a fourth receiving module, a fourth sending module, a second determination module, and a second obtaining module;
wherein the fourth receiving module is configured to receive a third request;
wherein the second determination module is configured to determine whether to configure an operator credential for a PINE based on a result of processing the third request using an operator private key;
wherein the fourth sending module is configured to send a fourth request to a third network element when it is determined to configure the operator credential for the PINE;
wherein the fourth receiving module is further configured to receive the operator credential returned based on the fourth request;
wherein the second obtaining module is configured to perform, using the operator private key, security processing on the operator credential to obtain the operator credential after security processing;
wherein the fourth sending module is further configured to send a third response to a first network element by carrying the operator credential after security processing in the third response.

A tenth aspect of an embodiment of the present disclosure provides an information processing apparatus, including:
a fifth receiving module configured to receive a fourth request from a second network element;
a configuration module configured to configure an operator credential for a PINE according to the fourth request, wherein the PINE is a device that is not configured with a default credential and is preconfigured with an operator public key;
a fifth sending module configured to send a fourth response to the second network element by carrying the operator credential in the fourth response, wherein the operator credential is used to be issued to the PINE after security processing with an operator private key corresponding to the operator public key.

An eleventh aspect of an embodiment of the present disclosure provides a communication device, including a processor, a transceiver, a memory, and an executable program stored in the memory and capable of being run by the processor, wherein when the processor runs the executable program, the information processing method according to any one of the first to fifth aspects described above is implemented.

A twelfth aspect of an embodiment of the present disclosure provides a computer storage medium, which stores an executable program; after the executable program is executed by a processor, the information processing method according to any one of the first to fifth aspects mentioned above is implemented.

In the technical solutions provided by the embodiments of the present disclosure, the operator public key is preconfigured in the PINE, so that the PINE can securely apply for an operator credential to the 3GPP network through a PEGC connection. Compared with performing the operator credential configuration after verification of a third-party default credential is passed, the operator credential procedure is shortened and the configuration rate of the operator credential is improved.

It should be understood that the foregoing general description and the following detailed description are exemplary and explanatory only and are not restrictive of the embodiments of the present disclosure.

### BRIEF DESCRIPTION OF THE DRAWINGS

The accompanying drawings, which are incorporated in and constitute a part of the specification, illustrate embodiments consistent with the present disclosure and, together with the specification, serve to explain the principles of the embodiments of the present disclosure.

FIG. 1 is a schematic structural diagram of a wireless communication system according to an example embodiment;

FIG. 2 is a schematic flowchart of an information processing method according to an example embodiment;

FIG. 3 is a schematic flowchart of an information processing method according to an example embodiment;

FIG. 4 is a schematic flowchart of an information processing method according to an example embodiment;

FIG. 5 is a schematic flowchart of an information processing method according to an example embodiment;

FIG. 6 is a schematic flowchart of an information processing method according to an example embodiment;

FIG. 7 is a schematic flowchart of an information processing method according to an example embodiment;

FIG. 8 is a schematic flowchart of an information processing method according to an example embodiment;

FIG. 9 is a schematic flowchart of an information processing method according to an example embodiment;

FIG. 10 is a schematic flowchart of an information processing method according to an example embodiment;

FIG. 11 is a schematic flowchart of an information processing method according to an example embodiment;

FIG. 12 is a schematic flowchart of an information processing method according to an example embodiment;

FIG. 13 is a schematic flowchart of an information processing method according to an example embodiment;

FIG. 14 is a schematic flowchart of an information processing method according to an example embodiment;

FIG. 15 is a schematic diagram showing the structure of an information processing apparatus according to an example embodiment;

FIG. 16 is a schematic diagram showing the structure of an information processing apparatus according to an example embodiment;

FIG. 17 is a schematic diagram showing the structure of an information processing apparatus according to an example embodiment;

FIG. 18 is a schematic diagram showing the structure of an information processing apparatus according to an example embodiment;

FIG. 19 is a schematic diagram showing the structure of an information processing apparatus according to an example embodiment;

FIG. 20 is a schematic diagram showing the structure of a PINE according to an example embodiment;

FIG. 21 is a schematic diagram showing the structure of a network element according to an example embodiment.

### DETAILED DESCRIPTION

Example embodiments will be described in detail herein, examples of which are illustrated in the accompanying drawings. When the following description refers to the drawings, the same numbers in different drawings refer to the same or similar elements unless otherwise indicated. The implementations described in the following example embodiments do not represent all implementations consistent with embodiments of the present disclosure. Rather, they are merely examples of apparatuses and methods consistent with some aspects of embodiments of the present disclosure.

The terms used in embodiments of the present disclosure are for the purpose of describing example embodiments only and are not intended to limit the embodiments of the present disclosure. As used in the present disclosure, the singular forms “a”, “an”, “said” and “the” are intended to include a plural form as well, unless the context clearly dictates otherwise. It will also be understood that the term “and/or” as used herein refers to and includes any and all possible combinations of one or more of associated listed items.

It should be understood that although the terms first, second, third, etc. may be used to describe various information in the embodiments of the present disclosure, the information should not be limited to these terms. These terms are only used to distinguish information of the same type from each other. For example, without departing from the scope of the embodiments of the present disclosure, first information may also be called second information, and similarly, second information may also be called first information. Depending on the context, the word “if” as used herein may be interpreted as “when” or “upon” or “in response to determining . . . ”.

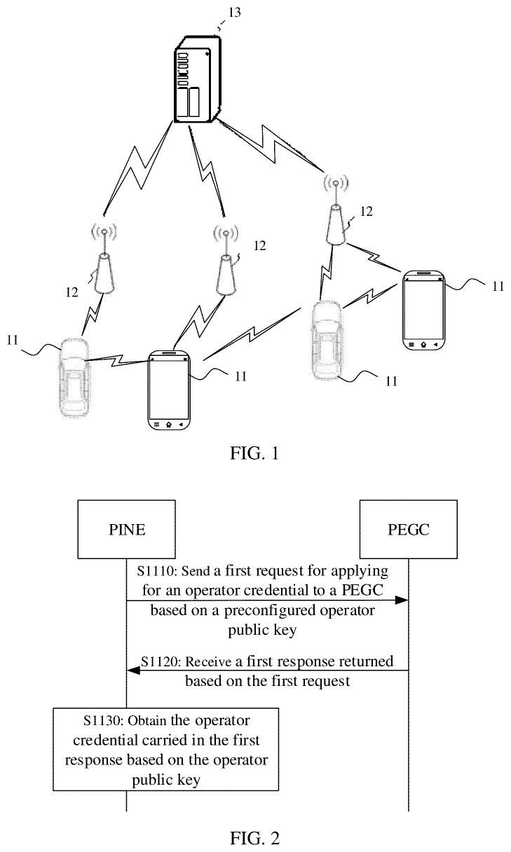

FIG. 1 shows a schematic structural diagram of a wireless communication system provided by an embodiment of the present disclosure. As shown in FIG. 1, the wireless communication system is a communication system based on cellular mobile communication technologies. The wireless communication system may include multiple UEs 11 and multiple access devices 12.

A UE 11 may be a device that provides voice and/or data connectivity to a user. The UE 11 may communicate with one or more core networks via a Radio Access Network (RAN). The UE 11 may be an Internet of Things UE, such as a sensor device, a mobile phone (or referred to as a “cellular” phone), and a computer with an Internet of Things UE, for example, it can be a fixed, portable, pocket-sized, handheld, computer-built-in or vehicle-mounted device. For example, the user equipment 110 may be a station (STA), a subscriber unit, a subscriber station, a mobile station, a mobile, a remote station, an access point, a remote UE (remote terminal), an access UE (access terminal), a user terminal, a user agent, a user device, or user equipment (UE). Alternatively, the UE 11 may be equipment of an unmanned aerial vehicle. Alternatively, the user equipment 110 may be a vehicle-mounted device, for example, it may be an on-board computer with a wireless communication function, or a wireless communication device connected to an external on-board computer. Alternatively, the UE 11 may be a roadside device, for example, it may be a streetlight, a signal light or other roadside device with a wireless communication function.

An access device 12 may be a network side device in a wireless communication system. The wireless communication system may be the 4th generation mobile communication (4G) system, also known as the Long Term Evolution (LTE) system; or, the wireless communication system may be a 5G system, also called new radio (NR) system or 5G NR system. Alternatively, the wireless communication system may be a next-generation system of the 5G system. The access network in the 5G system may be called New Generation-Radio Access Network (NG-RAN). Alternatively, it may be a MTC system.

The access device 12 may be an evolved access device (eNB) used in the 4G system. Alternatively, the access device 12 may be a access device (gNB) using a centralized distributed architecture in the 5G system. When the access device 12 adopts a centralized distributed architecture, it usually includes a central unit (CU) and at least two distributed units (DU). The central unit is provided with a protocol stack including a Packet Data Convergence Protocol (PDCP) layer, a Radio Link Control protocol (RLC) layer, and a Media Access Control (MAC) layer; a distributed unit is provided with a physical (PHY) layer protocol stack. The embodiments of the present disclosure do not limit the specific implementation of the access device 12.

A wireless connection may be established between an access device 120 and a UE 11 through a radio air interface. In different implementations, the radio air interface is a radio air interface based on the fourth generation mobile communication network technology (4G) standard; or, the radio air interface is a radio air interface based on the fifth generation mobile communication network technology (5G) standard, for example, the radio air interface is a new air interface; alternatively, the radio air interface may be a radio air interface based on the next generation mobile communication network technology standard of 5G.

There are three types of Personal IoT Network Element (PINE): a device with a gateway function (PIN Element with Gateway Capability, PEGC), a device with a management function (PIN Element with Management Capability, PEMC), and an ordinary PINE without gateway and management functions.

The PEGC and the PEMC may also be UEs that are able to directly access the 5G network. The PEMC may also access the 5G network through the PEGC.

The IoT devices that make up PINE include, but are not limited to: wearable devices, smart home devices, and/or smart office devices.

Wearable devices include but are not limited to: headphones, smart watches and/or health monitoring sensors.

Smart home devices include, but are not limited to: smart lights, cameras, thermostats, access control devices, voice assistant devices, speakers, refrigerators, washing machines, lawn mowers, and/or robots.

Smart office devices may be used in offices or factories of small businesses. Typical smart office devices include but are not limited to: printers, meters and/or sensors.

Some IoT devices have very specific requirements in terms of size (e.g. headphones), and some IoT devices have very specific requirements in terms of weight (e.g. glasses).

Some IoT devices have very specific requirements across multiple domains (i.e. size, weight, and power consumption).

A PINE is not able to directly access the 5G network, while the 5G network needs to identify the PINE for enhanced management. To fulfill the demand, the 5G network needs to provision an operator credential for the PINE. With the operator credential, the fifth generation mobile communication system (5th Generation System, 5GS) can authenticate and identify the PINE connected to the PEGC. Before provisioning the operator credential issued by 5GS to the PINE, a default credential of the PINE need to be authenticated. However, there is a lack of a mechanism to authenticate a default credential provided by a third-party Authentication, Authorization, and Accounting (AAA) server through 5GC, which delays the 5GC's communication control on the PIN E, resulting in communication latency.

As shown in FIG. 2, the present disclosure provides an information processing method. The method is performed by a PINE. The method includes:

In S1110, a first request for applying for an operator credential is sent to a PEGC based on a preconfigured operator public key.

In S1120, a first response returned based on the first request is received.

In S1130, the operator credential carried in the first response is obtained based on the operator public key.

The PINE may be IoT device of various types. For example, the IoT device includes: a wearable device that may be worn by a user, a device that may be carried by a user, a smart home device, a smart office device and/or a smart entertainment device used in an entertainment venue.

The operator public key may be a public key preconfigured by a communication operator. For example, the public key is written by the communication operator before the PINE is delivered to a consumer before it is launched on the market.

The communication operator may be a communication operator of a 3GPP network.

The PEGC may be any device that can access the 3GPP network, such as a user's mobile phone, a tablet computer, or a home gateway.

As an example, the PEGC may access the 3GPP network through a Subscriber Identity Module (SIM), which may be a physical card or an electronic SIM card built into a terminal.

Since the PINE is preconfigured with the operator public key, it is not needed to write a third-party default credential in the PINE in advance. The third-party default credential includes but is not limited to: a credential provided by an Authentication, Authorization, and Accounting (AAA) server.

In order to facilitate subsequent rapid access to the network by the PINE through the PEGC, after the PINE establishes a non-3GPP connection with the PEGC, the PINE may apply for the operator credential from the operator network through the PEGC.

As an example, after a secure non-3GPP connection is established between the PINE and the PEGC, the first request is sent to the PEGC to apply for the operator credential from a network element of a 3GPP network. The secure non-3GPP connection includes but is not limited to: a Bluetooth connection and/or a WiFi connection.

In an embodiment of the present disclosure, in order to achieve secure issuance of the operator credential, the PINE uses the preconfigured operator public key to perform security processing on the first request. Here, the security processing includes but is not limited to: encryption processing and/or signature verification processing.

In an embodiment, the first request may at least include: an identifier of the PINE. This can facilitate the network element of the 3GPP network to know the PINE that applies for the operator credential. As an example, the first request may further include: a credential configuration indicator, which is used to indicate that the PINE requests configuring the operator credential.

In another embodiment, the first request may further include a public key identifier of the operator public key. In this way, after the network element receives the first request, the network element can perform decryption and/or signature verification on at least part of the content in the first request based on an operator private key corresponding to the operator public key identified by the plaintext public key identifier.

If the PINE is identified by the 3GPP network element as being authorized to obtain the operator credential, the first response received by the PINE carries the operator credential configured for PINE. After receiving the first response, PINE uses the operator public key to process the first response, thereby obtaining the operator credential carried in the first response.

Therefore, in the embodiment of the present disclosure, by pre-configuring the operator public key in the PINE, the PINE can securely obtain the operator credential after connecting to the network through the PEGC.

In some embodiments, the first request may be a request message proposed in the related art, which is reused for configuring the operator credential for the PINE. By pre-configuring the operator public key in the PINE, the PINE can securely apply for the operator credential to the 3GPP network through the PEGC connection. Compared with a method in which the operator credential is configured after the verification of a third-party default credential is passed, the embodiments in the present disclosure can shorten the procedure for configuring the operator credential, and improve the configuration rate of the operator credential.

In some other embodiments, the first request may be dedicated for requesting an operator credential for a PINE, in which case the first request may not carry a credential configuration indicator.

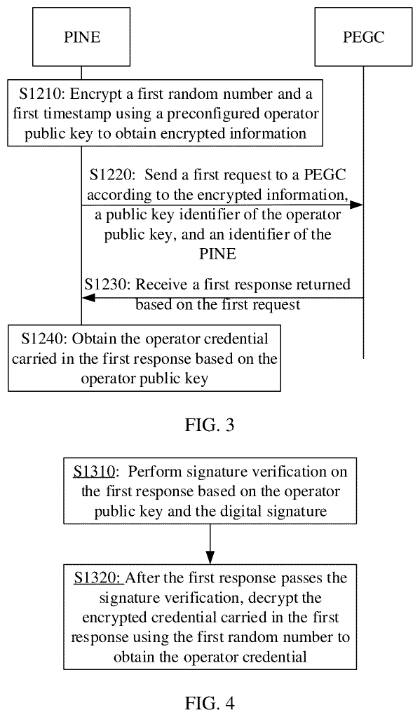

As shown in FIG. 3, an embodiment of the present disclosure provides an information processing method. The method is performed by a PINE. The method includes:

In S1210, a first random number and a first timestamp are encrypted using a preconfigured operator public key to obtain encrypted information.

In S1220, a first request is sent to a PEGC according to the encrypted information, a public key identifier of the operator public key, and an identifier of the PINE.

In S1230, a first response returned based on the first request is received.

In S1240, the operator credential carried in the first response is obtained based on the operator public key.

First, the PINE generates one first random number using a random algorithm. The length of the first random number may be pre-agreed, for example, agreed by a protocol. As an example, the length of the first random number may be 512 bits, 256 bits, 128 bits, etc.

In an embodiment, the length of the first random number is not less than the length of the operator credential.

The first timestamp may be: a timestamp of generating the first random number, and/or a timestamp of encrypting the first random number with the operator public key, or a timestamp of detecting the need to send the first request. In short, the first timestamp may represent a variety of times, and may be a timestamp of any operation of the PINE for applying for the operator credential, and is not limited to the above examples.

Then, the first random number and the first timestamp are encrypted using the preconfigured operator public key to obtain encrypted information. The encrypted information may be carried and added to an encrypted element. The encrypted element is an Information Element (IE). In an embodiment of the present disclosure, the first request at least includes the encrypted information.

Finally, the encrypted information, the public key identifier and the identifier of the PINE are carried together in the first request and sent to the PEGC. The public key identifier and the identifier of the PINE are carried in the first request in plaintext. Therefore, the first request includes a ciphertext part and a plaintext part, the ciphertext part at least includes the encrypted information, and the plaintext part at least includes the public key identifier and the identifier of the PINE.

It is worth noting that: in order to further improve security, a signature key known to both a second network element and the PINE may be used again to perform integrity protection on a part or all of the encrypted information, the public key identifier and/or the identifier of the PINE to obtain a message authentication code. The message authentication code may be used for signature verification by the 3GPP network element later, thereby reducing information tampering during transmission.

Due to the randomness of the value generated by the first random number itself and the randomness of the time when different PINEs generate the first random number, the first random number and the first timestamp can be used by the network element at the network side to perform replay attack verification on the first request, thereby reducing the phenomenon in which old requests are sent, merged and intercepted illegitimately to repeatedly request an operator credential from the network element of the 3GPP network again.

In some embodiments, the PINE may also generate a second random number. When encrypting the first random number, the second random number may also be encrypted. Therefore, the encrypted information may include not only the first random number and the first timestamp but also the second random number.

The encrypted information further includes: a second random number encrypted using the operator public key;
sending the first request for applying for the operator credential to the network element based on the preconfigured operator public key includes:
performing integrity protection on the encrypted information, the public key identifier of the operator public key, an identifier of an integrity protection algorithm and the identifier of the PINE using the second random number to generate a message authentication code; and sending the first request to the PEGC based on the encrypted information, the public key identifier of the operator public key, the identifier of the PINE and the message authentication code.

The second random number carried in the first request is encrypted, but the message authentication code is carried in plaintext in the first request. In addition, the identifier of the integrity protection algorithm indicates the integrity protection algorithm used to generate the message authentication code, and identifier of the integrity protection algorithm may also be carried in plaintext in the first request.

In an embodiment of the present disclosure, in order to enhance the security of the first request, the first request is digitally signed to achieve integrity protection.

In an embodiment of the present disclosure, integrity protection is performed using the second random number generated by the PINE. A character string of a preset length is used to calculate a message authentication code for integrity protection. The preset length may be any length known to both the PINE and the network element. The character string may be determined based on the second random number.

As an example, assuming that the preset length is 128 bits, the PINE may perform one of the following operations

If the second random number generated by the PINE exceeds 128 bits, the 128 least significant bits or 128 most significant bits are used to perform integrity protection on the encrypted information, the identifier of the integrity protection algorithm, the public key identifier and the identifier of the PINE to obtain a message authentication code. The message authentication code is also carried in the first request and sent to the network element at the network side.

If the random number generated by the PINE is equal to 128 bits, the entire second random number is used to perform digital signature on the encrypted information, the public key identifier, the identifier of the integrity protection algorithm and the identifier of the PINE to obtain a message authentication code.

If the second random number generated by the PINE is less than 128 bits, two or more second random numbers are concatenated to obtain a 128-bit character string, and then the concatenated character string is used to perform integrity protection on the encrypted information, the identifier of the integrity protection algorithm, the public key identifier and the identifier of the PINE to obtain a message authentication code.

In this way, after receiving the encrypted information, the public key identifier, the identifier of the PINE, the identifier of the integrity protection algorithm, and the message authentication code, the network element (for example, the second network element) at the network side use a private key to decrypt the encrypted information to obtain the second random number, the first timestamp and the first random number in plaintext, and then use the second random number to perform integrity protection on the encrypted information, the identifier of the integrity protection algorithm, the public key identifier, and the identifier of the PINE to generate a message authentication code. Then, the generated message authentication code is compared with the message authentication code received from the PINE. If the two are consistent, it is considered that the first request passes the integrity protection verification, and it is determined that the first request has not been tampered with during the transmission procedure, which further improves the security of the first request.

In some embodiments, if the PINE is preconfigured with an integrity protection algorithm supported by a network element at the network side, the second random number may be used to perform integrity protection on the ciphertext information, the identifier of the integrity protection algorithm, the identifier of the PINE and the public key identifier to obtain the message authentication code. In this case, the first request carries the message authentication code.

If the PINE is not preconfigured with an integrity protection algorithm supported by the network element at the network side, the second random number may not be used to perform integrity protection on the ciphertext information, the identifier of the PINE and the public key identifier. In this case, the first request does not carry the message authentication code.

In some embodiments, performing integrity protection on the encrypted information, the identifier of the integrity protection algorithm, the public key identifier of the operator public key, and the identifier of the PINE using the second random number to obtain the message authentication code may include:
using the second random number, a transmission direction value, a bearer identifier and a counter value, performing integrity protection calculation on a message formed by the encrypted information, the public key identifier of the operator public key, the identifier of the integrity protection algorithm and the identifier of the PINE to obtain the message authentication code.

The second random number is used as an integrity protection key of the integrity protection algorithm.

The transmission direction value and the bearer identifier may both be preset values. The preset values corresponding to the transmission direction value and the bearer identifier may be the same or different.

In an embodiment, the counter value may also be set to a specific value, and the specific value may be a value known by the PINE and the second network element such as an AUSF.

In another embodiment, the counter value may be a value of a counter with a length of 32 bits or 64 bits, and the counter value may be the value of a user parameter update counter maintained by both the PINE and the second network element.

Of course, the above is only an example of calculating the message authentication code based on an integrity algorithm, and the specific implementation is not limited to this example.

In some embodiments, as shown in FIG. 4, the first response includes: a digital signature. The digital signature may be generated by the second network element.

Obtaining the operator credential carried in the first response based on the operator public key includes the following steps:

In S1310, signature verification is performed on the first response based on the operator public key.

In S1320, after the first response passes the signature verification, the encrypted credential carried in the first response is decrypted using the first random number to obtain the operator credential. The first response carrying the encrypted credential is returned after the encrypted information is successfully decrypted and the encrypted information is verified to be not subject to a replay attack according to the first random number and the first timestamp.

In some embodiments, the first response includes a digital signature performed on the encrypted credential and the second timestamp using the operator private key. Performing the signature verification on the first response based on the operator public key may include:

after the digital signature is successfully verified using the operator public key, implementing verification of whether the encrypted credential and the second timestamp have been tampered with, that is, implementing verification of whether the encrypted credential and the second timestamp have been integrally protected during the transmission procedure.

Specifically, the encrypted credential and the second timestamp are digitally signed using the operator public key to obtain a locally generated digital signature; and the received digital signature is compared with the locally generated digital signature. If the received digital signature is the same as the locally generated digital signature, it is considered that the first response passes the signature verification.

After the signature verification of the first response is passed, decryption of the encrypted credential carried in the first response is continued to obtain the operator credential in plaintext.

In an embodiment, if the network element at the network side uses the operator public key corresponding to the operator private key to encrypt the operator credential to obtain an encrypted credential, the PINE uses the operator private key to decrypt the encrypted credential to obtain the operator credential in plaintext.

In another embodiment, if the network element at the network side uses the random number sent in the first request to encrypt the operator credential, the PINE may use the first random number generated by itself to decrypt the encrypted credential, thereby obtaining the operator credential in plaintext. If the first random number generated by PINE is used to encrypt or decrypt the operator credential, the integrity protection and confidentiality protection of the first response use different keys, thereby further improving the security of the first response.

In some embodiments, the first response further includes: a second timestamp.

The second timestamp may be: a timestamp for configuring the operator credential for the PINE, or a timestamp for encrypting the operator credential to obtain the encrypted credential, etc. The second timestamp included in the first response may be used by the PINE to verify whether the first response is subject to a replay attack.

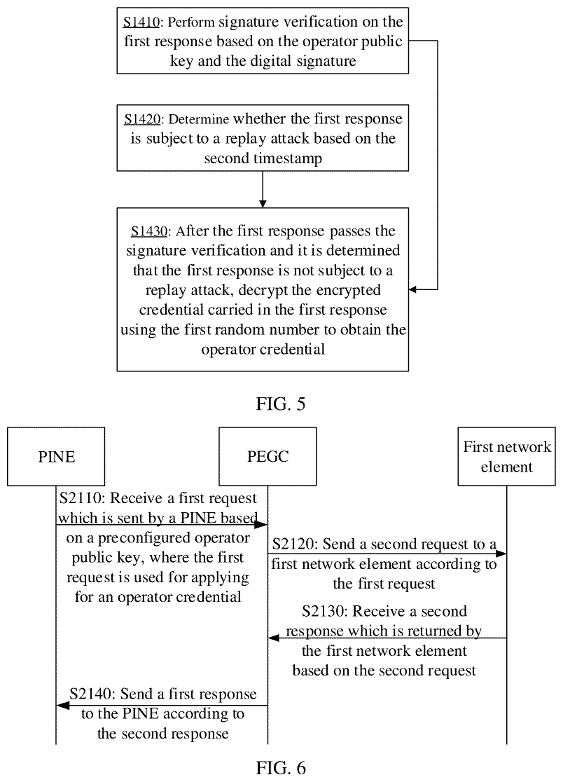

In some embodiments, as shown in FIG. 5, obtaining the operator credential carried in the first response based on the operator public key includes the following steps:

In S1410, signature verification is performed on the first response based on the operator public key.

In S1420, whether the first response is subject to a replay attack is determined based on the second timestamp.

In S1430, after the first response passes the signature verification and it is determined that the first response is not subject to a replay attack, the encrypted credential carried in the first response is decrypted using the first random number to obtain the operator credential.

Since the second timestamp may be carried in plaintext in the first response, there is no specific order between the replay attack verification and the integrity verification.

For example, in an embodiment, after completing the integrity protection verification of the encrypted credential and the second timestamp using the operator public key, whether the first response is subject to a replay attack is determined according to the second timestamp.

For another example, in another embodiment, before or during signature verification of the first response, replay attack verification is performed based on the second timestamp carried in the first response.

Determining of whether the encrypted credential is subject to a replay attack may include at least one of the following:
if the time indicated by the second timestamp received by the PINE is earlier than the time indicated by the first timestamp, it may be considered that the first response is subject to a replay attack;
first calculation time moment is obtained by summing the time indicated by the second timestamp and a first time offset value; if the first calculation time moment is earlier than the current time moment, it may be considered that the first response is subject to a replay attack;
second calculation time moment is obtained by summing the time indicated by the second timestamp and a second time offset value; if the second calculation time moment is earlier than the current time moment, it may be considered that the first response is subject to a replay attack;
the second time offset value is greater than the first time offset value.

In summary, there are many ways to verify whether the first response is subject to a replay attack based on the second timestamp, and examples are not given here one by one.

In an embodiment of the present disclosure, when the first response passes the signature verification and it is determined that the first response is not subject to a replay attack, the encrypted credential is decrypted using the first random number to obtain the operator credential for the PINE.

If the first response does not pass the integrity protection verification or it is determined that the first response is subject to a replay attack, decryption of the first response is stopped.

Furthermore, the method further includes: when the first response does not pass the integrity protection verification or it is determined that the first response is subject to a replay attack, sending an attack alarm prompt to the network through the PEGC; and/or, when the first response does not pass the integrity protection verification or it is determined that the first response is subject to a replay attack, re-sending a first request for applying for an operator credential based on the operator public key.

In some embodiments, the method further includes:
when the first response includes a credential confirmation indicator and the operator credential is correctly received, generating, using the operator public key, a first reception confirmation value indicating that the operator credential is correctly received; and sending the first reception confirmation value to the PEGC.

In some embodiments, the first response may include a credential confirmation indicator, and if the PINE correctly receives the operator credential, it is needed to send a first reception confirmation value to the network; otherwise, the PINE does not send the first reception confirmation value to the network, or sends a credential failure prompt.

In some embodiments, if the PINE sends the first reception confirmation value to the network, the PINE also sends the credential confirmation indicator to the network along with the first reception confirmation value. In this case, the credential confirmation indicator is used to inform the network of the first reception confirmation value currently sent by the PINE.

Before sending the first reception confirmation value to the network, the PINE first generates the first reception confirmation value according to the operator public key.

As an example, the first receipt confirmation value is generated using the operator public key and the operator credential as input parameters.

As another example, the first reception confirmation value is generated with the operator public key, the length of the operator public key, the identifier of the PINE and the length of the identifier of the PINE as input parameters.

In short, there are many ways to generate the first reception confirmation value, and the specific implementation is not limited to any of the above examples. However, if the input parameters for generating the first reception confirmation value are parameters known by the network element at the network side, it is convenient for the network element at the network side to verify the first reception confirmation value without further obtaining input parameters.

In the embodiment of the present disclosure, the receipt confirmation of the operator credential is no longer a simple reception indicator, but a unique first reception confirmation value, thereby reducing the forged receipt confirmation of the operator credential.

In some embodiments, generating, using the operator public key, the first receipt confirmation value indicating that the operator credential is correctly received includes:
generating the first reception confirmation value according to the operator public key, the operator credential and the identifier of the PINE.

For example, the encrypted credential and the identifier of the PINE are encrypted using the operator public key to obtain the first reception confirmation value.

As another example, the encrypted credential, the first random number and the identifier of the PINE are encrypted using the operator public key to obtain the first reception confirmation value.

In an embodiment, sending the first receipt confirmation value to the PEGC includes: sending the first receipt confirmation value and the credential confirmation indicator to the PEGC.

As an example, the length of the credential confirmation indicator is: the length of the binary credential indicator. The length of the identifier of the PINE is: the length of the binary identifier of the PINE. The above length may be the number of bits.

In an embodiment, the credential confirmation indicator may be used to indicate that the operator credential is correctly received, and the first reception confirmation value may be used by the network element to verify whether the operator credential is correctly received by the PINE.

In another embodiment, the credential confirmation indicator is only used to indicate that a message carrying the credential confirmation indicator carries the first reception confirmation value.

The above merely shows examples of generating the first reception confirmation value, and the specific implementation is not limited to the above examples.

As shown in FIG. 6, an embodiment of the present disclosure provides an information processing method. The method is performed by a PEGC, and the method includes:

In S2110, a first request which is sent by a PINE based on a preconfigured operator public key is received. The first request is used for applying for an operator credential.

In S2120, a second request is sent to a first network element according to the first request.

In S2130, a second response which is returned by the first network element based on the second request is received.

In S2140, a first response is sent to the PINE according to the second response.

The PEGC may be a device that has obtained an operator credential earlier than the PINE and has registered with the 3GPP network.

A secure non-3GPP connection is established between the PEGC and the PINE If a PINE not configured with an operator credential is connected to the PEGC, the PEGC receives the first request from the PINE. A part of information in the first request is securely protected by the operator credential preconfigured in the PINE.

After receiving the first request, the PEGC encapsulates the content carried by the first request into a second request and sends it to the first network element.

If the network element at the network side configures the operator credential for the PINE, the PEGC receives a second response, and the second response carries the operator credential.

In S2140, the second response is sent to the PINE as a container or an IE carried in the first response. In this way, the PINE can receive the operator credential configured by the network element for the PINE, or the PINE can know whether the network element has configured the operator credential for the PINE.

In some embodiments, the second request includes the content of the first request and further includes at least one of the following:
a credential configuration indicator indicating application for the operator credential;
an identifier of the PEGC, wherein the identifier of the PEGC is used to check whether the PEGC is legitimate.

In an embodiment, the second request may be a request dedicated to configuring an operator credential for a PINE, and in this case, the second request may carry or not carry the credential configuration indicator.

In another embodiment, the second request may be an existing request for other information transmission, which is reused to apply for an operator credential for a PINE. In this case, the second request may carry a credential configuration indicator to explicitly indicate that the current second request is used to apply for an operator credential for the PINE.

In an embodiment, the second request carries the identifier of the PEGC. The device identifier of the PEGC (or the identifier of the PEGC or the PEGC identifier for short) may include but is not limited to: a Subscription Concealed Identifier (SUCI) and/or a Subscription Permanent Identifier (SUPI) of the PEGC.

If the PEGC is verified as legitimate, the network element confirms that the various information for applying for the operator credential is trusted; otherwise, it is not trusted, and the network element can stop configuring the operator credential for the PINE.

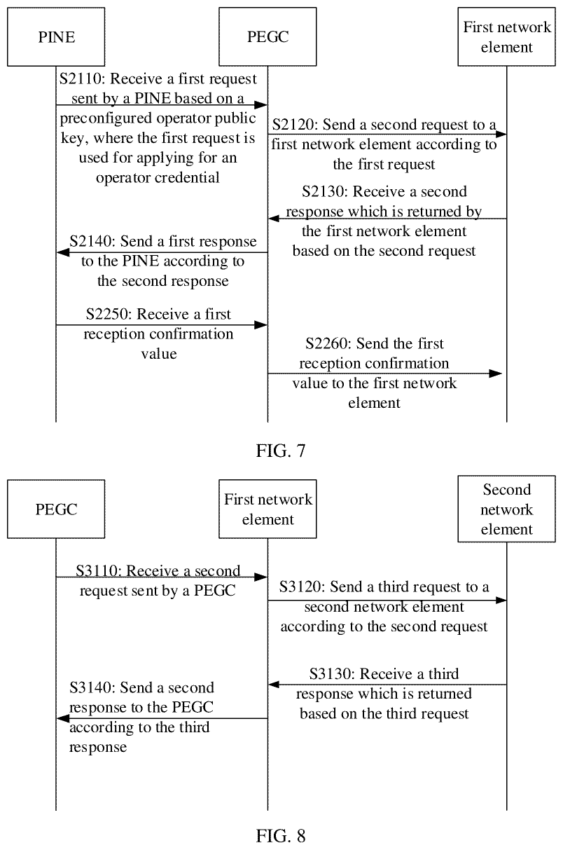

As shown in FIG. 7, an embodiment of the present disclosure provides an information processing method. The method is performed by a PEGC, and the method includes:

In S2110, a first request sent by a PINE based on a preconfigured operator public key is received. The first request is used for applying for an operator credential.

In S2120, a second request is sent to a first network element according to the first request.

In S2130, a second response which is returned by the first network element based on the second request is received.

In S2140, a first response is sent to the PINE according to the second response.

In S2250, a first reception confirmation value is received. The first reception confirmation value is generated by the PINE based on the operator public key, an encrypted credential and the identifier of the PINE after the PINE correctly receives the operator credential.

In S2260, the first reception confirmation value is sent to the first network element.

The encrypted credential is generated after the operator credential configured for PINE is encrypted. As an example, the operator credential configured for the PINE is encrypted using a random number provided by the PINE to obtain the encrypted credential.

In an embodiment, the PEGC sends the first reception confirmation value to the first network element after receiving the first reception confirmation value.

In another embodiment, after receiving the first reception confirmation value, the PEGC attaches a credential confirmation indicator and sends them to the first network element.

In yet another embodiment, the PEGC receives the first reception confirmation value and a credential confirmation indicator from the PINE, and sends the first reception confirmation value and the credential confirmation indicator together to the first network element.

As shown in FIG. 8, an embodiment of the present disclosure provides an information processing method. The method is performed by a first network element, and the method includes:

In S3110, a second request sent by a PEGC is received. The second request is sent based on a first request. The first request is a request which is sent by a PINE based on a preconfigured operator public key and is used for applying for an operator credential.

In S3120, a third request is sent to a second network element according to the second request.

In S3130, a third response which is returned based on the third request is received.

In S3140, a second response is sent to the PEGC according to the third response.

The first network element includes but is not limited to various network elements of a core network. As an example, the first network element may be an Access and Mobility Management Function (AMF).

The first network element can serve as a network element for the PEGC to communicate with the network element for configuring the operator credential, and can serve as an intermediate network element for the PEGC to communicate with other network element(s).

After receiving the second request from the PEGC, the first network element sends the third request to the second network element according to the second request. The third request includes the second request. As an example, the second request is added to a container or an IE in the third request and sent to the second network element.

The first network element subsequently receives the third response returned by the second network element in response to the third request. After receiving the third response, the first network element returns the second response to the PEGC. As an example, the third response is added to a container or an IE in the second response.

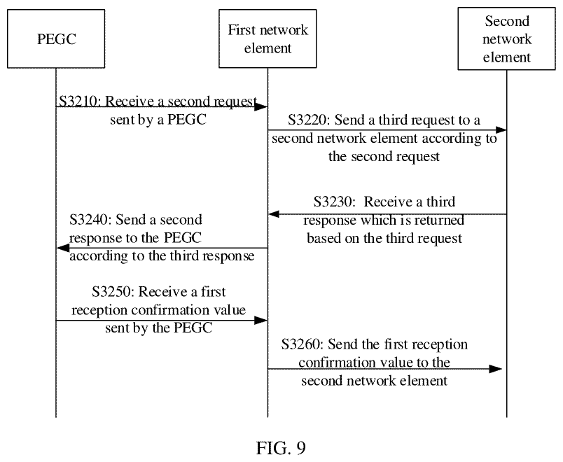

As shown in FIG. 9, an embodiment of the present disclosure provides an information processing method. The method is performed by a first network element, and the method includes:

In S3210, a second request sent by a PEGC is received. The second request is sent based on a first request. The first request is a request which is sent by a PINE based on a preconfigured operator public key and is used for applying for an operator credential.

In S3220, a third request is sent to a second network element according to the second request.

In S3230, a third response which is returned based on the third request is received.

In S3240, a second response is sent to the PEGC according to the third response.

In S3250, a first reception confirmation value sent by the PEGC is received. The first reception confirmation value is generated by the PINE based on the operator public key, an encrypted credential and the identifier of the PINE after the PINE correctly receives the operator credential.

In S3260, the first reception confirmation value is sent to the second network element.

If PINE correctly receives the operator credential and the third response carries a credential confirmation indicator, the PINE generates the first reception confirmation value, and the first network element sends the first reception confirmation value to the second network element.

In some other embodiments, the following is also sent along with the first reception confirmation value: a credential response indicator provided by the PEGC or the PINE. In this case, the first network element sends the first reception confirmation value and the credential response indicator to the second network element.

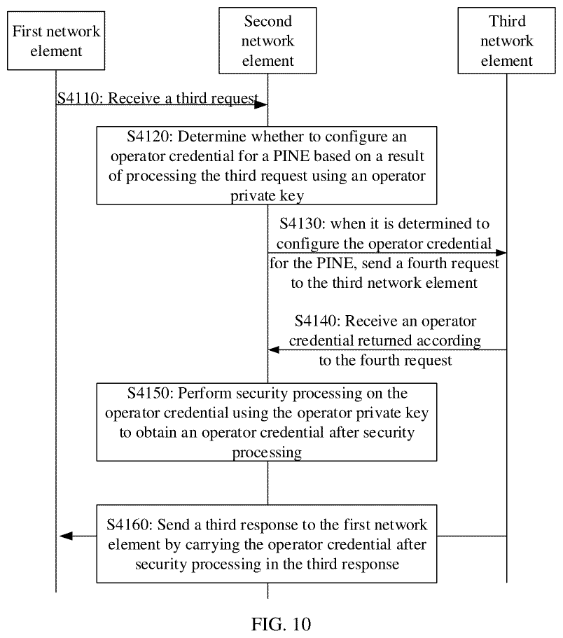

As shown in FIG. 10, an embodiment of the present disclosure provides an information processing method. The method is performed by a second network element. The method includes:

In S4110, a third request is received.

In S4120, whether to configure an operator credential for a PINE is determined based on a result of processing the third request using an operator private key.

In S4130, when it is determined to configure the operator credential for the PINE, a fourth request is sent to the third network element.

In S4140, an operator credential returned according to the fourth request is received.

In S4150, security processing is performed on the operator credential using the operator private key to obtain an operator credential after security processing.

In S4160, a third response is sent to the first network element by carrying the operator credential after security processing in the third response.

The second network element may also be a network element of the core network. As an example, the second network element includes but is not limited to an Authentication Server Function (AUSF).

The third request comes from the first network element. After receiving the third request from the first network element, the operator private key corresponding to the operator public key is used to process the third request to obtain a processing result. According to the processing result, whether to configure the operator credential for the PINE is determined.

If it is determined to configure the operator credentials for the PINE, the fourth request is sent to the third network element, and the fourth request is used for requesting the third network element to configure the operator credential for the PINE. If it is determined not to configure the operator credential for the PINE, the configuration process is stopped.

The fourth response returned by the third network element based on the fourth request is received. The fourth response includes: the operator credential configured by the third network element for the PINE, where the operator credential is in plaintext.

After receiving the operator credential, in order to ensure the secure issuance of the operator credential to the PINE, the operator private key is used to process the operator credential in plaintext to obtain the operator credential after security processing.

In some embodiments, the operator private key may be used to decrypt the operator credential encrypted by the operator public key, or to perform integrity protection on the operator credential, etc.

The operator credential after security processing may be directly returned from the second network element to the first network element, or may be returned to the third network element and then returned by the third network element to the PINE via the second network element, the first network element and the PEGC.

In short, the operator credential after security processing is returned to the first network element.

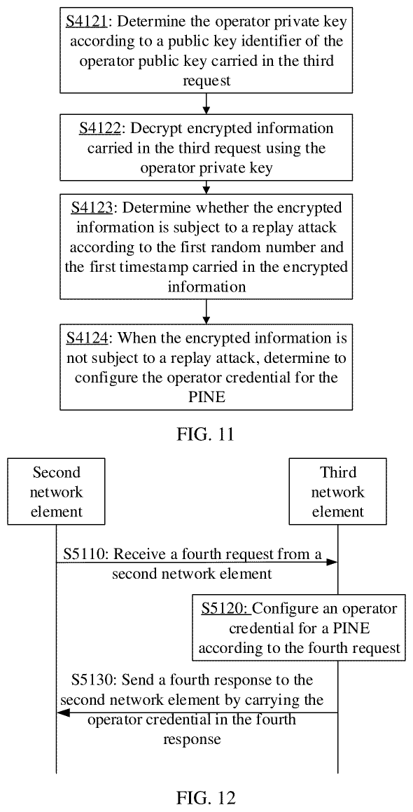

In some embodiments, as shown in FIG. 11, S4120 may include the following steps:

In S4121, the operator private key is determined according to a public key identifier of the operator public key carried in the third request.

In S4122, encrypted information carried in the third request is decrypted using the operator private key to obtain a first random number and a first timestamp.

In S4123, whether the encrypted information is subject to a replay attack is determined according to the first random number and the first timestamp.

In S4124, when the encrypted information is not subject to a replay attack, it is determined to configure the operator credential for the PINE.

The operator public key preconfigured in the PINE and the operator private key stored in the second network element are a key pair in asymmetric encryption.

Based on the public key identifier of the operator public key carried in the third request, by querying the key pair information, the operator private key can be obtained.

The encrypted information carried in the third request is decrypted using the operator private key. The encrypted information may include at least: a random number and a first timestamp of the PINE. After the encrypted information is decrypted, the random number and the first timestamp provided by the PINE are obtained.

In some embodiments, after the second network element decrypts the encrypted information to obtain the first random number and the first timestamp, the second network element determines whether the second network element has ever received the encrypted information based on a combination of the first random number and the first timestamp. If the second network element has ever received the encrypted information, it can be considered that the encrypted information is subject to a replay attack.

In some other embodiments, the second network element may also determine whether the encrypted information is subject to a replay attack based on a time difference between the time when the first random number is generated as indicated by the first timestamp and the time when the third request is received. For example, if the time difference is too large or too small, the encrypted information may be subject to a replay attack.

The above shows only examples of determining whether the encrypted information is subject to a replay attack, and the specific implementation is not limited to the above examples.

In some embodiments, the encrypted information further includes: a second random number; the third request further includes a message authentication code, and the method further includes:
performing integrity protection verification on a message of the encrypted information, the public key identifier, the identifier of the integrity protection algorithm, and the identifier of the PINE according to the message authentication code and the second random number;
when the encrypted information is not subject to a replay attack, determining to configure the operator credential for the PINE includes:
when the encrypted information is not subject to a replay attack and the integrity protection verification is passed, determining to configure the operator credential for the PINE.

In some embodiments, the encrypted information, the identifier of the integrity protection algorithm, the public key identifier, and the identifier of the PINE may be integrity protected. If they are integrity protected, the encrypted information also includes an encrypted second random number, and the third request also includes a message authentication code generated by the PINE, and the second network element also obtains the message authentication code from the third request. If the message authentication code is successfully obtained from the third request, the second network element uses the decrypted second random number to perform integrity protection verification on the encrypted information, the public key identifier, the identifier of the integrity protection algorithm, and the identifier of the PINE to obtain a locally generated message authentication code. The received message authentication code is compared with the locally generated message authentication code. If the two are consistent, it is considered that the integrity protection verification of the first request is passed, and the integrity of the first request is protected; otherwise, it can be considered that the first request has been tampered with during transmission.

In an embodiment of the present disclosure, the second random number generated by the PINE is used for integrity protection verification. A character string of a preset length is used for digital signature. The preset length may be any length known to both the PINE and the network element. The character string may be determined based on the second random number.

As an example, assuming that the preset length is 128 bits, the PINE may perform one of the following operations:
if the second random number generated by the PINE exceeds 128 bits, the 128 least significant bits or the 128 most significant bits are used to perform integrity protection verification on the encrypted information, the identifier of the integrity protection algorithm, the public key identifier and identifier of the PINE to obtain a locally generated message authentication code;
if the second random number generated by the PINE is equal to 128 bits, the entire random number is used to perform integrity protection verification on the encrypted information, the public key identifier, the identifier of the integrity protection algorithm, and identifier of the PINE to obtain a locally generated message authentication code;
if the second random number generated by the PINE is less than 128 bits, two or more second random numbers are concatenated to obtain a 128-bit character string, and then the concatenated character string is used to perform integrity protection verification on the encrypted information, the identifier of the integrity protection algorithm, the public key identifier and identifier of the PINE to obtain a locally generated message authentication code.

Therefore, in some embodiments, the encrypted information further includes: a second random number; the third request further includes a message authentication code, and the method further includes:
performing integrity protection verification on a message of the encrypted information, the public key identifier, the identifier of the integrity protection algorithm, and the identifier of the PINE according to the message authentication code and the second random number;
determining to configure the operator credential for the PINE when the encrypted information is not subject to a replay attack includes:
when the encrypted information is not subject to a replay attack and the integrity protection verification is passed, determining to configure the operator credential for the PINE.

Through the integrity protection verification, the configuration security of the operator credential can be further improved.

As an example, when the second network element fails to obtain the message authentication code from the third request, it is considered that the PINE does not preconfigure the integrity protection algorithm, and no integrity protection verification is performed. When it is determined that the encrypted information is not subject to a replay attack, it is determined to configure the operator credential for the PINE.

In some embodiments, S4150 may include:
encrypting the operator credential according to the first random number included in the encrypted information to obtain an encrypted credential; and
signing the encrypted credential and the second timestamp for generation of the encrypted credential using the operator private key to obtain a digital signature.

The operator credential in plaintext is received from the third network element. The first random number is used as an encryption key, and the operator credential is encrypted according to an agreed confidentiality algorithm to obtain an encrypted credential. The confidentiality algorithm may be agreed by a protocol.

In the embodiment of the present disclosure, the random number provided by the PINE can be used to verify whether the encrypted information is subject to a replay attack, and can also serve as a key to encrypt the operator credential, thereby achieving dual use of one piece of information.

Furthermore, the encrypted credential and the second timestamp for the encrypted credential are digitally signed using the operator private key. Specifically, the operator private key, the encrypted credential itself and the second timestamp are used as input parameters to generate a digital signature for signature verification.

In a case where the second network element has only one operator private key, confidentiality protection and integrity protection are performed for the operator credential at the same time.

In some embodiments, encrypting the operator credential according to the first random number included in the encrypted information to obtain the encrypted credential includes:
performing bitwise XOR on the first random number and the operator credential to obtain the encrypted credential.

In a case, when the length of the binary bits of the first random number is equal to the length of the binary bits of the operator credential, a bitwise XOR is directly performed.

In another case, if the number of binary bits of the first random number is greater than that of the operator credential, the S most significant bits or the S least significant bits of the binary character string of the first random number are bitwise XORed with the operator credential, where S is the number of binary bits of the operator credential.

In another case, if the number of binary bits of the first random number is less than that of the operator credential, the binary bits of random numbers can be repeatedly concatenated until a concatenated binary character string with a length equal to or greater than S bits is obtained. If the concatenated binary character string is greater than S, the S most significant bits or the S most significant bits may be bitwise XORed with the operator credential.

In the embodiments of the present disclosure, the encryption of the operator credential is implemented by using the bitwise XOR of the first random number and the operator credential. The specific implementation is not limited to the above examples.

In some embodiments, the method further includes:
when the encrypted information is subject to a replay attack, stopping the operator credential configuration for the PINE; and/or
when the integrity protection verification is not passed, stopping the operator credential configuration for the PINE.

In the embodiment of the present disclosure, if the encrypted information from PINE fails the replay attack verification and/or the integrity protection verification is not passed, it is determined that the configuring of the operator credential is not performed, thereby improving the configuration security of the operator credential.

In some embodiments, the method further includes:
sending the operator credential after security processing to the third network element;
sending the fourth response to the second network element by carrying the operator credential after processing in the fourth response includes:
receiving a configuration result provided by the third network element based on the operator credential after security processing; and
sending the fourth response to the first network element by carrying the operator credential after security processing in the fourth response.

Sending the operator credential after security processing to the third network element may include:
signing the encrypted credential and the second timestamp using the operator private key to obtain the digital signature, and sending the digital signature, the encrypted credential and the second timestamp to the third network element.

After the digital signature, the encrypted credential and the second timestamp are sent to the third network element, the configuration result returned by the third network element is received. The second network element includes the configuration result in the third response and returns it to the first network element.

In some embodiments, the configuration result may include: the digital signature, the encrypted credential, the second timestamp, the identifier of the PEGC, and the identifier of the PIN.

In some other embodiments, the configuration result may include: the digital signature, the encrypted credential, the second timestamp, the identifier of the PEGC, the identifier of the PINE, and a credential response indicator, etc. The credential response indicator may be used to indicate the PINE to return the first reception confirmation value after the PINE correctly receives the operator credential.

In another embodiment, after the second network element generates the digital signature, the second network element does not return the digital signature, the encrypted credential and the second timestamp to the third network element, but directly returns the third response carrying the digital signature, the encrypted credential and the second timestamp to the first network element. If the PINE is required to send the first receipt confirmation value when the PINE correctly receives the operator credential, the second network element sends a credential response indicator to the first network element at the same time as sending the digital signature to the first network element. In some embodiments, the credential response indicator may also be referred to as a credential reception indicator.

In some embodiments, the operator credential after security processing is carried in the third response and sent to the first network element. In some embodiments, the method further includes:
generating a second reception confirmation value;
receiving a first reception confirmation value sent by the first network element;
when the second reception confirmation value is the same as the first reception confirmation value, determining that the PINE correctly receives the operator credential; and
sending to the third network element a notification that the operator credential is correctly received.

In some embodiments, the second network element not only generates the digital signature, the encrypted credential and the second timestamp, but also generates a second reception confirmation value. After receiving the first reception confirmation value from the PINE, the two confirmation values are compared to determine whether the PINE correctly receives the operator credential. If it is determined that PINE correctly receives the operator credential, a corresponding notification is sent to the third network element, and the notification indicates the configuration result of the operator credential; otherwise, no notification indicating that the operator credential is correctly received is sent to the third network element, or a notification indicating that the operator credential is not correctly received is sent.

In this embodiment, the second reception confirmation value does not need to be transmitted to the third network element, and the comparison between the second reception confirmation value and the first reception confirmation value is performed by the second network element, thereby shortening the procedure for configuring the operator credential for the PINE and improving the configuration efficiency.

It is worth noting that: in the scheme where the second network element compares the first reception confirmation value with the second reception confirmation value, after the second network element generates the digital signature, the encrypted credential and the second timestamp, it directly includes the digital signature in the third response and returns it to the first network element without returning the digital signature, the encrypted credential and the second timestamp to the third network element.

In another embodiment, the method further includes:
generating a second reception confirmation value, and providing the second reception confirmation value along with the operator credential after security processing to the third network element;
receiving a first reception confirmation value sent by the first network element; and
sending the first reception confirmation value to the third network element, wherein the first reception confirmation value is used for the third network element to determine whether the PINE correctly receives the operator credential based on the second reception confirmation value and the first reception confirmation value.

Different from the previous embodiment, in this embodiment, the second network element returns the second reception confirmation value generated by itself to the third network element, and the first reception confirmation value provided by the PINE is also be transmitted to the third network element. The third network element compares the first reception confirmation value and the second reception confirmation value to determine whether the PINE correctly receives the operator credential.

In some embodiments, when receiving the first reception confirmation value, the second network element also receives a credential confirmation indicator.

In some embodiments, generating the second receipt confirmation value includes:
generating the second reception confirmation value according to the operator public key, the operator credential and the identifier of the PINE.

There are many ways to generate the first reception confirmation value and the second reception confirmation value. The above shows specific examples. The specific implementation is not limited to the above examples. For other methods, reference may be made to corresponding parts of the aforementioned embodiments, which will not be repeated here.

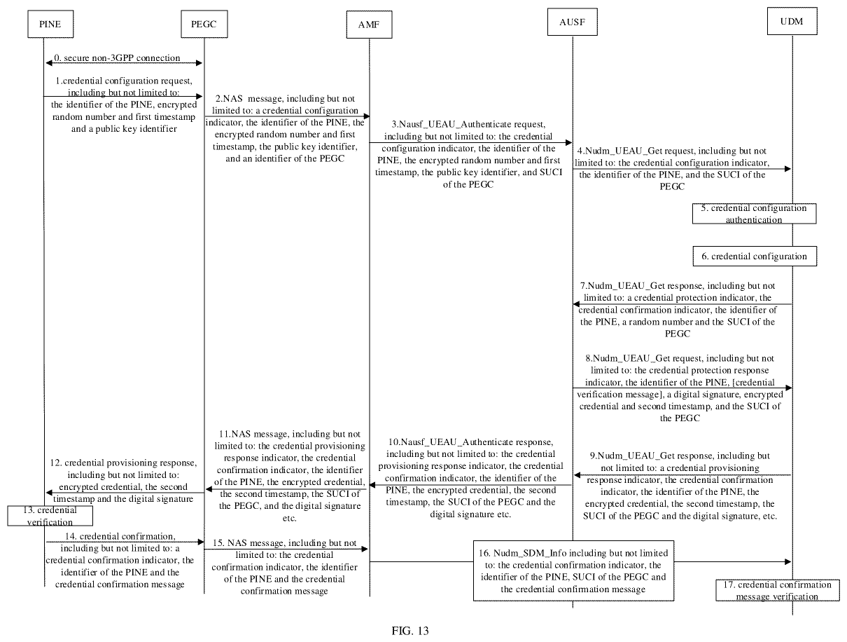

As shown in FIG. 12, an embodiment of the present disclosure provides an information processing method. The method is performed by a third network element, and the method further includes:

In S5110, a fourth request from a second network element is received.

In S5120, an operator credential is configured for a PINE according to the fourth request.

In S5130, a fourth response is sent to the second network element by carrying the operator credential in the fourth response, wherein the operator credential is used to be issued to the PINE after security processing with an operator private key corresponding to an operator public key.

The third network element may also be a network element of the core network, including but not limited to a Data Management Function (UDM).

The PINE may be a device preconfigured with at least the operator public key; or, the PINE may be a device that is not configured with a default credential and is preconfigured with the operator public key.

The fourth request is received from the second network element. After receiving the fourth request, the operator credential is configured for the PINE. After the operator credential configuration is completed, the operator credential is returned to the second network element, and the second network element performs security processing.

The security process includes, but is not limited to, encryption protection and/or integrity protection and/or replay attack protection processing.

In this way, the operator credential issued to PINE is at least protected by the operator private information, thus achieving the secure issuance of operator credential.

In some embodiments, the method further includes:
receiving the operator credential after security processing returned by the second network element;
generating a configuration result including the operator credential after security processing; and
sending the configuration result to the third network element.

Receiving the operator credential after security processing returned by the second network element includes: receiving an encrypted credential returned by the second network element; or receiving the encrypted credential, a digital signature, and a second timestamp sent by the second network element.

In some embodiments, if the third network element wants the PINE to return a first reception confirmation value indicating that the operator credential is correctly received by the PINE, the third network element adds a credential response indicator to the digital signature, the encrypted credential, and the second timestamp to form the configuration result, and then returns the configuration result to the second network element which sends the configuration result to the PINE.

If the operator credential after security processing is not returned to the third network element, and the third network element requires the PINE to return the first reception confirmation value indicating that the operator credential is correctly received by the PINE, the third network element provides the credential response indicator and the operator credential in plaintext to the second network element. In this way, the second network element subsequently generates the encrypted credential, the second timestamp and the digital signature, and then returns the credential response indicator, the encrypted credential, the second timestamp and the digital signature together in the third response to the first network element, and finally issue it to the PINE.

In some embodiments, the method further includes:
receiving a second reception confirmation value generated by the second network element;
receiving a first reception confirmation value generated by the PINE; and when the first reception confirmation value and the second reception confirmation value are the same, determining that the PINE correctly receives the operator credential.

If the PINE returns the first reception confirmation value and the third network element performs reception verification, the third network element first receives the second reception confirmation value from the second network element after the second network element generates the second reception confirmation value, and when the PINE returns the first reception confirmation value, the third network element compares the locally stored second reception confirmation value with the first reception confirmation value to determine whether the PINE correctly receives the operator credential.

In another embodiment, if the comparison between the first reception confirmation value and the second reception confirmation value is performed by the second network element, the information processing method performed by the third network element further includes: receiving from the second network element a notification that the operator credential is correctly received.

At this time, if the third network element receives the notification, it is considered that the PINE correctly receives the operator credential configured by the third network element; otherwise, it is considered that the PINE does not correctly receives the operator credential.

In some embodiments, the method further includes:
before configuring the operator credential for the PINE, checking whether the PEGC connected to the PINE is legitimate;
configuring the operator credential for the PINE according to the fourth request includes:
when the PEGC is legitimate, configuring the operator credential for the PINEE according to the fourth request.

The fourth request carries at least the identifier of the PEGC. The third network element can determine whether the PEGC connected to the PINE is legitimate based on the identifier of the PEGC. If it is legitimate, the third network element continues to configure the operator credential for the PINE; otherwise, the third network element does not configure the operator credential for the PINE.

It is assumed that a PINE establishes a secure non-3GPP connection with a PEGC.

It is assumed that the PINE is preconfigured with a public key of an operator, rather than a default credential provided by a third-party AAA server. The public key of the operator is the aforementioned operator public key, and is a public key configured by the operator.

The PEGC has registered to the 5G Core Network (5GC). The connection between the PEGC and an AMF is protected by Non-Access Stratum (NAS) security. Referring to FIG. 13, an embodiment of the present disclosure provides an information processing method, which may include the following:
0. The PINE is securely connected to the PEGC via a non-3GPP connection.
1. The PINE sends a credential configuration request to the PEGC. The request carries the identifier of the PINE, encrypted random number and first timestamp, and a public key identifier. For example, the PINE sends the request for applying for an operator credential to the PEGC. Specifically, the PINE first generates a random number of a predetermined length (e.g., 256 bits). Then, the PINE encrypts the random number and the first timestamp (timestamp p1) using the preconfigured operator public key. The request includes an encrypted element, the identifier of the PINE and the public key identifier of the operator public key. The first timestamp may be an encryption timestamp of the PINE and/or a generation timestamp of the random number. The encrypted element may include at least: the random number and the first timestamp encrypted using the operator public key. The device identifier of the PINE includes, but is not limited to: the International Mobile Equipment Identity (IMEI) of the PINE and/or the MAC address of the PINE.
2. After receiving the request, the PEGC sends the request to the AMF via a NAS message. The NAS message may include: a credential configuration indicator, the identifier of the PINE, the encrypted random number and first timestamp, the public key identifier, and an identifier of the PEGC. The credential configuration indicator is used to indicate that the PINE applies for configuring of an operator credential. The identifier of the PEGC includes but is not limited to the SUCI and/or SUPI of the PEGC.
3. The AMF sends the credential configuration indicator, the device identifier of the PINE, the encrypted random number, the encrypted first timestamp (timestamp p1), the public key identifier of the operator public key, and SUCI of the PEGC to the AUSF through a credential configuration request service operation. The credential configuration request service service operation may be a newly defined operation or reuse the existing Nausf_UEAU_Authenticate service operation.
4. The AUSF sends to the UDM a request for applying for the operator credential. Before sending the request to the UDM, the AUSF retrieves the corresponding operator private key based on the public key identifier of the operator public key. Then, the AUSF decrypts the encrypted element in the request for applying for the operator credential. If the AUSF detects a replay attack based on the timestamp P1 and the random number, the AUSF terminates the credential issuance process. The credential configuration request includes the credential configuration indicator (credential configuration request indicator), the identifier of the PINE, a random number, and the SUCI of the PEGC. The credential issuance service operation may be a newly defined operation or reuse the existing Nudm_UEAU_Get response operation.
5. UDM performs credential configuration authentication. Specifically, the UDM checks whether the PEGC is a legitimate gateway based on the SUCI of the PEGC. The UDM determines whether PEGC is a legitimate gateway authorized to request the operator credential based on the subscription information of the PEGC. If the PEGC is an authorized legitimate gateway, the UDM starts to generate the operator credential for the PINE; otherwise, the UDM terminates the configuration of the operator credential for the PINE.
6. UDM performs credential configuration. Specifically, the UDM generates the operator credential for the PINE. The UDM stores the operator credential, the SUCI of the PEGC, and the device identifier of the PINE.
7. The UDM sends a credential provisioning response message to the AUSF. The message may include: a credential protection indicator, the credential confirmation indicator, the identifier of the PINE, a random number and the SUCI of the PEGC. The credential protection request includes the credential protection indicator, so that the AUSF receives the operator credential provided by the UDM and performs security protection on the operator credential.

The credential protection request may be delivered through a newly defined service operation or by reusing the existing Nudm_UEAU_Get service operation. The credential protection request may indicate requesting the AUSF to perform security protection of the operator credential. The credential confirmation indicator, on the one hand, indicates that the AUSF generates a second reception confirmation value which is to be compared with the first reception confirmation value of the PINE; on the other hand, the credential confirmation indicator is sent to the PINE to indicate that the PINE returns the first reception confirmation value when the operator credential is correctly received.
8. A Nudm-UEAU-Get request is provided to the UDM, and the request includes: a credential protection response indicator, the identifier of the PINE, [credential verification message, i.e., the second receipt confirmation value], a digital signature (the digital signature is the aforementioned digital signature), encrypted credential and second timestamp, and the SUCI of the PEGC. The credential protection response indicator may indicate that the AUSF provides security protection for the operator credential.

Specifically, when the credential confirmation indicator indicates that the UDM requires a credential confirmation from the PINE, the AUSF encrypts the encrypted credential and the identifier of the PINE using the operator public key to construct a credential verification message (i.e., the aforementioned second reception confirmation value).

A part or all of the random number equal to the length of the operator credential is XORed with the operator credential to obtain the encrypted credential. For example, when the length of the random number is greater than the length of the operator credential, the len(operation credential) least significant bits of the random number is XORed with the operator credential, where the len(operation credential) represents the length of the operator credential.

The AUSF leverages an operator private key to generate a digital signature for the encrypted credentials and timestamp2. The AUSF sends the credential protection response to the UDM. The credential protection response includes the newly generated digital signature, the credential protection response indicator, the device identifier of the PINE, timestamp p2, the encrypted credential and the SUPI of the PEGC. The credential protection response indicator indicates that AUSF has performed security processing for the operator credential.

If the UDM requires credential confirmation information (i.e., the first received confirmation value) from the PINE, the credential protection response also includes a credential verification message. The credential protection response may be delivered through a newly defined service operation or by reusing the existing Nudm_UEAU_Get service operation.
9. The UDM sends a credential provisioning response to the AUSF. The credential provisioning response includes a credential provisioning response indicator, the credential confirmation indicator, the device identifier of the PINE, the encrypted credential, the second timestamp (timestamp p2), the digital signature and the SUCI of the PEGC. The credential issuance response may be delivered through the newly defined service operation or the existing Nudm_UEAU_Get service operation.

The provisioning response indicator indicates that the operator credential has been configured for the PINE, and the PINE is required to return a receipt confirmation value after correctly receiving the operator credential.
10. The AUSF sends the credential configuration response to the AMF. The credential configuration response includes: the credential configuration response indicator, a credential confirmation indicator, the device identifier of the PINE, the encrypted credential, the second timestamp (timestamp p2), and the digital signature. The credential configuration response may be delivered through a newly defined service operation or the existing Nudm_UEAU_Get service operation. The credential configuration response indicator is used to indicate that the message is in response to the request for applying for the operator credential.
11. The AMF sends the credential configuration response to the PEGC.
12. The PEGC sends the credential configuration response to the PINE.
13. After the PINE receives the credential configuration response, the PINE verifies the response. Specifically, the PINE first verifies the digital signature using the operator public key. If the credential configuration response is determined to be tampered with based on the verification result of the digital signature, the procedure for configuring the operator credential is terminated; otherwise, the PINE verifies whether the credential configuration response is subject to a replay attack based on the second timestamp. If the credential configuration response is not subject to a replay attack, the PINE obtains the operator credential in plaintext by XORing a random number with the encrypted credential. If the credential configuration response is subject to a replay attack, the process is terminated.
14. The credential confirmation indicator indicates that the PINE is required to return the first receipt confirmation value (or credential verification message) to the UDM to indicate that the credential is correctly received. The PINE generates the first receipt confirmation value based on the identifier of the PINE and the operator credential in plaintext.
15. The PEGC sends the credential confirmation indicator, the identifier of the PINE and the first receipt confirmation value to the AMF.
16. The AMF provides the identifier (e.g., SUCI) of the PEGC, the credential confirmation indicator, the identifier of the PINE and the first reception confirmation value (i.e., credential confirmation information) to the corresponding UDM. The credential confirmation information may be delivered using a newly defined operation or the existing Nudm_SDM_Info service operation.
17. Credential confirmation message verification. Upon receiving the credential confirmation message, the UDM compares the locally stored second receipt confirmation value with the first receipt confirmation value to verify whether the operator credential is correctly received. If the two are consistent, it is determined that the operator credential configuration is successful, otherwise the configuration fails.

It is assumed that a PINE has established a secure non-3GPP connection with a PEGC. It is assumed that the PINE is preconfigured with an operator public key instead of a default credential generated by a third-party AAA server. The PEGC has registered with 5GC. The connection between the PEGC and an AMF is protected by NAS security.

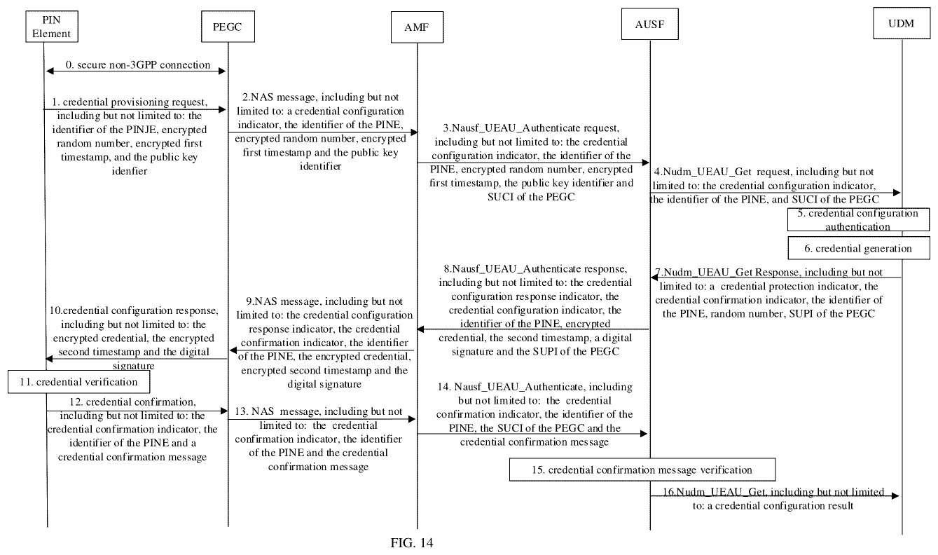

As shown in FIG. 14, an information processing method provided by an present disclosure may include:
0. The PINE is securely connected to the PEGC via a non-3GPP connection.
1. The PINE sends a request for applying for an operator credential to the PEGC. Specifically, the PINE first generates a random number of a predetermined length (256 bits). Then, the PINE constructs an encrypted random number and an encrypted first timestamp (timestamp p1) using the preconfigured operator public key. The request includes: an encrypted element, a device identifier of the PINE, and a public key identifier of the operator public key.
2. After receiving the request, the PEGC sends the request to an AMF via a NAS message.
3. The AMF sends a credential configuration indicator, the device identifier of the PINE, encrypted random number, encrypted first timestamp (timestamp p1), a public key identifier of the operator public key, and SUCI of the PEGC to an AUSF through a credential configuration request service operation. The credential configuration request service operation may be a newly defined operation or reuse the existing Nausf_UEAU_Authenticate service operation.
4. The AUSF sends to a UDM a request for applying for the operator credential. Before sending the request to the UDM, the AUSF retrieves the corresponding operator private key based on the public key identifier of the operator public key. Then, the AUSF uses the operator private key to decrypt the encrypted element in the request for applying for the operator credential. The AUSF performs replay attack detection based on the first timestamp and the random number carried by the request. If it is detected that the request is subject to a replay attack, the AUSF terminates the credential issuance process. The request includes: the credential configuration indicator, the device identifier of the PINE, a random number and SUCI of the PEGC. The credential issuance service operation involved in the request executed by the AUSF may be a newly defined operation or may reuse the existing Nudm_UEAU_Get service operation.
5. Based on the SUCI of the PEGC, UDM first checks whether the PEGC is a legitimate gateway. For example, based on the subscription information of the PEGC, the UDM checks whether the PEGC is a gateway authorized to apply for the operator credential. If the PEGC is authorized to serve as a gateway to apply for the operator credential, the PEGC passes the legitimacy verification, and the UDM starts to configuring the operator credential for the PINE; otherwise, the UDM terminates the procedure for configuring the credential.
6. The UDM generates the operator credential for the PINE. The UDM stores the operator credential, the SUCI of the PEGC, and the device identifier of the PINE.
7. The UDM sends a credential provisioning response message to the AUSF. The credential provisioning response message contains a credential protection request. The credential protection request includes: a credential protection indicator, the credential confirmation indicator, the device identifier of the PINE, the operator credential, SUPI of the PEGC. The credential protection request may be delivered through a newly defined service operation or by reusing the existing Nudm_UEAU_Get service operation.
8. When the credential confirmation indicator indicates that the UDM requires operator credential receipt confirmation from the PINE,
the AUSF uses the operator public key to encrypt the encrypted credential and the identifier of the PINE to construct a credential verification message (i.e., the aforementioned second reception confirmation value).

A part or all of a random number equal to the length of the operator credential is XORed with the operator credential to obtain an encrypted credential. For example, when the length of the random number is greater than the length of the operator credential, the len(operation credential) least significant bits of the random number is XORed with the operator credential, where the len(operation credential) represents the length of the operator credential.

The AUSF leverages an operator private key to generate a digital signature for the encrypted credential and the timestamp2. The AUSF sends a credential protection response to the UDM. The credential protection response includes the newly generated digital signature, a credential protection response indicator, the device identifier of the PINE, timestamp p2, the encrypted credential and the SUPI of the PEGC. The credential protection response indicator indicates that AUSF has performed security processing for the operator credential.

If the UDM requires credential confirmation information (i.e., the first received confirmation value) from the PINE, the credential protection response also includes a credential verification message. The credential protection response may be delivered through a newly defined service operation or by reusing the existing Nudm_UEAU_Get service operation.
9. The AMF sends a credential provisioning response to the PEGC via a NAS message.
10. The PEGC sends the credential provisioning response to the PINE.
11. After receiving the credential provisioning response, the PINE verifies the credential provisioning response.

Specifically, the PINE first uses the operator public key to verify the signature of the response to implement integrity protection verification. When performing the integrity protection verification, if it is found that the credential provisioning response has been tampered with, the PINE terminates the procedure for configuring the credential; otherwise, the PINE checks whether the credential provisioning response is subject to a replay attack based on the second timestamp. If the credential provisioning response is not subject to a replay attack, the PINE uses a local random number to perform an XOR process on the encrypted credential, thereby decrypting the encrypted credential to obtain the operator credential in plaintext; otherwise, the PINE terminates the procedure.
12. If the credential issuance response indicator indicates that the UDM requires a credential confirmation message from the PINE, the PINE sends the credential confirmation message, the credential confirmation indicator, and the device identifier of the PINE to the PEGC. The credential confirmation message includes: the plaintext operator credential and the device identifier that are encrypted by the operator public key
13. The PEGC sends the credential confirmation message, the credential confirmation indicator, and the device identifier of the PINE to the AMF.
14. The AMF forwards the credential confirmation message provided by the PEGC to the AUSF. The credential confirmation message sent by the AMF includes: SUCI of the PEGC, the credential confirmation message, the credential confirmation indicator, and device identifier of PINE are sent to the corresponding AUSF. The message may be delivered through a newly defined service operation or the Nausf_UEAU_Authenticate service operation.
15. After receiving the credential confirmation message, the AUSF compares a locally stored credential confirmation message with the credential confirmation message. If the two are different, the AUSF considers that the operator credential configuration for PINE is wrong; otherwise, the AUSF considers that the operator credential configuration for PINE is correct.
16. The AUSF notifies the UDM of the credential configuration result.

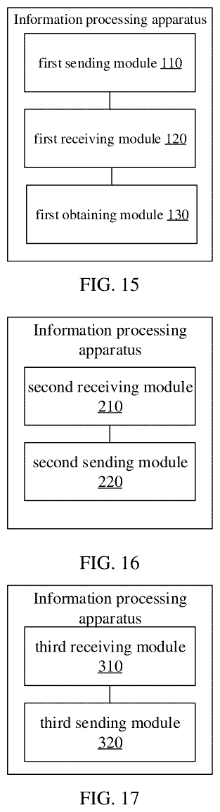

As shown in FIG. 15, an embodiment of the present disclosure provides an information processing apparatus. The apparatus includes: a first sending module 110, a first receiving module 120 and a first obtaining module 130.

The first sending module 110 is configured to send a first request for applying for an operator credential to a PIN Element with Gateway Capability (PEGC) based on a preconfigured operator public key.

The first receiving module 120 is configured to receive a first response returned based on the first request.

The first obtaining module 130 is configured to obtain the operator credential carried in the first response based on the operator public key.

The information processing apparatus may be included in a PINE.

In some embodiments, the first sending module 110, the second receiving module 120, and the first obtaining module 130 may be program modules; after the program modules are executed by a processor, any of the aforementioned operations can be implemented.

In some other embodiments, the first sending module 110, the second receiving module 120 and the first obtaining module 130 may be a combination of software and hardware modules; the combination of software and hardware modules includes but is not limited to various programmable arrays. The programmable arrays include but are not limited to: field programmable arrays and/or complex programmable arrays.

In some other embodiments, the first sending module 110, the second receiving module 120 and the first obtaining module 130 may be pure hardware modules. The pure hardware modules include but are not limited to application specific integrated circuits.

In some embodiments, the first sending module 110 is configured to: encrypt a first random number and a first timestamp using the preconfigured operator public key to obtain encrypted information; and send the first request to the PEGC according to the encrypted information, a public key identifier of the operator public key and an identifier of a PINE.

In some embodiments, the encrypted information further includes: a second random number encrypted using the operator public key;
the first obtaining module 130 is specifically configured to: perform integrity protection on the encrypted information, a public key identifier of the operator public key, an identifier of an integrity protection algorithm and the identifier of the PINE using the second random number to generate a message authentication code; and send the first request to the PEGC based on the encrypted information, the public key identifier of the operator public key, the identifier of the PINE and the message authentication code.

The first obtaining module 130 is configured to: perform signature verification on the first response based on the operator public key; after the first response passes the signature verification, decrypt an encrypted credential carried in the first response using the first random number to obtain the operator credential, wherein the first response carrying the encrypted credential is returned after the encrypted information is successfully decrypted and the encrypted information is verified to be not subject to a replay attack according to the first random number and the first timestamp.

In some embodiments, the first response further includes a second timestamp, and the apparatus further includes:
a first determination module configured to determine, according to the second timestamp, whether the first response is subject to a replay attack;
wherein the first obtaining module 130 is configured to, when the first response passes the signature verification and it is determined that the first response is not subject to the replay attack, decrypt the encrypted credential using the first random number to obtain the operator credential for the PINE.

In some embodiments, the apparatus further includes:
a first generation module configured to, when the first response includes a credential confirmation indicator and the operator credential is correctly received, generate, using the operator public key, a first reception confirmation value indicating that the operator credential is correctly received;
wherein the first sending module 110 is configured to send the first reception confirmation value to the PEGC.

In some embodiments, the first generation module is configured to generate the first receipt confirmation value according to the operator public key, the operator credential and an identifier of a PINE.

In some embodiments, the first sending module 110 is configured to send the first reception confirmation value and the credential confirmation indicator to the PEGC.

In some embodiments, the first request includes:
a public key identifier of the operator public key; and
the identifier of the PINE.

As shown in FIG. 16, an embodiment of the present disclosure provides an information processing apparatus. The apparatus is applied in a PEGC. The apparatus includes a second receiving module 210, and a second sending module 220.

The second receiving module 210 is configured to receive a first request which is sent by a PINE based on a preconfigured operator public key, wherein the first request is used for applying for an operator credential;
the second sending module 220 is configured to send a second request to a first network element according to the first request;
the second receiving module 210 is further configured to receive a second response which is returned by the first network element based on the second request;
the second sending module 220 is further configured to send a first response to the PINE according to the second response.

The information processing apparatus may be included in the PEGC.

In some embodiments, the second receiving module 210 and the second sending module 220 may be program modules; after the program modules are executed by a processor, any of the aforementioned operations can be implemented.

In some other embodiments, the second receiving module 210 and the second sending module 220 may be a combination of software and hardware modules. The combination of software and hardware modules includes but is not limited to various programmable arrays. The programmable arrays include but are not limited to: field programmable arrays and/or complex programmable arrays.

In some other embodiments, the second receiving module 210 and the second sending module 220 may be pure hardware modules. The pure hardware modules include but are not limited to application specific integrated circuits.

In some embodiments, the second request includes a content of the first request, and further includes at least one of the following:
a credential configuration indicator indicating application for the operator credential; or
an identifier of a PEGC, wherein the identifier of the PEGC is used to check whether the PEGC is legitimate.

In some other embodiments, the second receiving module 210 is further configured to receive a first reception confirmation value, wherein the first reception confirmation value is generated by the PINE based on the operator public key, an encrypted credential and an identifier of the PINE after the PINE correctly receives the operator credential;
wherein the second receiving module 210 is further configured to send the first reception confirmation value to the first network element.

As shown in FIG. 17, an embodiment of the present disclosure provides an information processing apparatus. The apparatus includes a third receiving module 310 and a third sending module 320.

The third receiving module 310 is configured to receive a second request sent by a PEGC, wherein the second request is sent based on a first request, wherein the first request is a request which is sent by a PINE based on a preconfigured operator public key and is used for applying for an operator credential;
the third sending module 320 is configured to send a third request to a second network element according to the second request;
the third receiving module 310 is configured to receive a third response returned based on the third request;
the third sending module 320 is configured to send a second response to the PEGC according to the third response.

The information processing apparatus may be included in a first network element, and the first network element includes but is not limited to an AMF.

In some embodiments, the third receiving module 310 and the third sending module 320 may be program modules; after the program modules are executed by a processor, any of the aforementioned operations can be implemented.

In some other embodiments, the third receiving module 310 and the third sending module 320 may be a combination of software and hardware modules. The combination of software and hardware modules includes but is not limited to various programmable arrays. The programmable arrays include but are not limited to: field programmable arrays and/or complex programmable arrays.

In some other embodiments, the third receiving module 310 and the third sending module 320 may be pure hardware modules. The pure hardware modules include but are not limited to application specific integrated circuits.

In some embodiments, the third receiving module 310 is configured to receive a first reception confirmation value sent by the PEGC, wherein the first reception confirmation value is generated by the PINE based on the operator public key, an encrypted credential and an identifier of the PINE after the PINE correctly receives the operator credential;
wherein the third sending module 320 is configured to send the first reception confirmation value to the second network element.

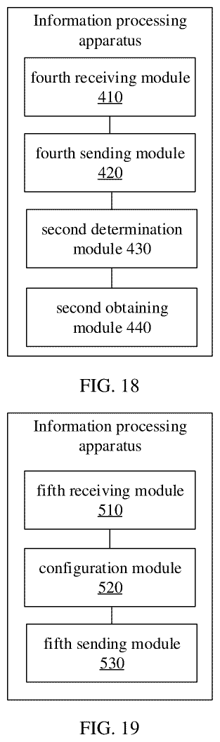

As shown in FIG. 18, an embodiment of the present disclosure provides an information processing method. The apparatus includes a fourth receiving module 410, a fourth sending module 420, a second determination module 430 and a second obtaining module 440.

The fourth receiving module 410 is configured to receive a third request;
the second determination module 430 is configured to determine whether to configure an operator credential for a PINE based on a result of processing the third request using an operator private key;
the fourth sending module 420 is configured to send a fourth request to a third network element when it is determined to configure the operator credential for the PINE;
the fourth receiving module 410 is further configured to receive the operator credential returned based on the fourth request;
the second obtaining module 440 is configured to perform, using the operator private key, security processing on the operator credential to obtain the operator credential after security processing;
the fourth sending module 420 is further configured to send a third response to a first network element by carrying the operator credential after security processing in the third response.

The information processing apparatus may be included in a second network element, and the second network element includes but is not limited to an AUSF.

In some embodiments, the fourth receiving module 410, the fourth sending module 420, the second determination module 430, and the second obtaining module 440 may be program modules; after the program modules are executed by a processor, any of the aforementioned operations can be implemented.

In some other embodiments, the fourth receiving module 410, the fourth sending module 420, the second determination module 430 and the second obtaining module 440 may be a combination of software and hardware modules. The combination of software and hardware modules includes but is not limited to various programmable arrays. The programmable arrays include but are not limited to: field programmable arrays and/or complex programmable arrays.

In some other embodiments, the fourth receiving module 410, the fourth sending module 420, the second determination module 430 and the second obtaining module 440 may be pure hardware modules. The pure hardware modules include but are not limited to application specific integrated circuits.

In some embodiments, the second determination module 430 is configured to: determine the operator private key according to a public key identifier of an operator public key carried by the third request;
decrypt encrypted information carried in the third request using the operator private key;
determine whether the encrypted information is subject to a replay attack according to a first random number and a first timestamp carried by the encrypted information; and
when the encrypted information is not subject to a replay attack, determine to configure the operator credential for the PINE.

In some embodiments, the encrypted information further includes a second random number, and the third request further includes a message authentication code,
wherein the apparatus further includes:
a verification module configured to perform integrity protection verification on a message of the encrypted information, the public key identifier, an identifier of an integrity protection algorithm and an identifier of the PINE according to the message authentication code and the second random number;
wherein the second determination module 420 is configured to determine to configure the operator credential for the PINE when the encrypted information is not subject to a replay attack and the integrity protection verification is passed.

In some embodiments, the second obtaining module 440 is configured to: encrypt the operator credential according to a first random number included in encrypted information to obtain an encrypted credential; and sign, using the operator private key, the encrypted credential and a second timestamp for generation of the encrypted credential to obtain a digital signature.

In some embodiments, the second obtaining module 440 is configured to perform bitwise XOR on the first random number and the operator credential to obtain the encrypted credential.

In some embodiments, the apparatus further includes:
a stopping module configured to: stop operator credential configuration for the PINE when the encrypted information is subject to a replay attack; and/or, stop the operator credential configuration for the PINE when integrity protection verification is not passed.

In some embodiments, the fourth sending module 420 is configured to send the operator credential after security processing to the third network element;
wherein the fourth receiving module 410 is further configured to receive a configuration result provided by the third network element based on the operator credential after security processing;
wherein the fourth sending module 420 is further configured to send the third response including the configuration result to the first network element.

In some embodiments, the fourth sending module 420 is configured to send the third response including the operator credential after security processing to the first network element after the operator credential after security processing is generated.

In some embodiments, the apparatus further includes:
a second generation module configured to generate a second reception confirmation value;
wherein the fourth receiving module 410 is configured to receive a first reception confirmation value sent by the first network element;
wherein the apparatus further includes:
a third confirmation module configured to determine that the PINE correctly receives the operator credential when the second reception confirmation value is the same as the first reception confirmation value;
wherein the fourth sending module is configured to send to the third network element a notification that the operator credential is correctly received.

In some embodiments, the apparatus further includes:
a second generation module configured to generate a second reception confirmation value;
wherein the fourth sending module 420 is further configured to provide the second reception confirmation value along with the operator credential after security processing to the third network element;
wherein the fourth receiving module 410 is configured to receive a first reception confirmation value sent by the first network element;
wherein the fourth sending module 420 is configured to send the first reception confirmation value to the third network element, wherein the first reception confirmation value is used for the third network element to determine, based on the second reception confirmation value, whether the PINE correctly receives the operator credential.

In some embodiments, the second generation module is configured to generate the second receipt confirmation value according to an operator public key, the operator credential and an identifier of the PINE.

As shown in FIG. 19, an embodiment of the present disclosure provides an information processing apparatus. The apparatus further includes a fifth receiving module 510, a configuration module 520 and a fifth sending module 530.

The fifth receiving module 510 is configured to receive a fourth request from a second network element;
the configuration module 520 is configured to configure an operator credential for a PINE according to the fourth request, wherein the PINE is a device that is not configured with a default credential and is preconfigured with an operator public key;
the fifth sending module 530 is configured to send a fourth response to the second network element by carrying the operator credential in the fourth response, wherein the operator credential is used to be issued to the PINE after security processing with an operator private key corresponding to the operator public key.

The information processing apparatus may be included in a third network element, and the third network element includes but is not limited to a UDM.

In some embodiments, the fifth receiving module 510, the configuration module 520, the second determination module and the fifth sending module 530 may be program modules; after the program modules are executed by a processor, any of the aforementioned operations can be implemented.

In some other embodiments, the fifth receiving module 510, the configuration module 520, the second determination module and the fifth sending module 530 may be a combination of software and hardware modules. The combination of software and hardware modules includes but is not limited to various programmable arrays. The programmable arrays include but are not limited to: field programmable arrays and/or complex programmable arrays.

In some other embodiments, the fifth receiving module 510, the configuration module 520, the second determination module and the fifth sending module 530 may be pure hardware modules. The pure hardware modules include but are not limited to application specific integrated circuits.

In some embodiments, the fifth receiving module 510 is configured to receive the operator credential returned by the second network element after security processing;
wherein the apparatus further includes:
a third generation module configured to generate a configuration result including the operator credential after the security processing;
wherein the fifth sending module 530 is configured to send the configuration result to the second network element.

In some embodiments, the fifth receiving module 510 is configured to receive a second reception confirmation value generated by the second network element;
wherein the fifth receiving module 510 is configured to receive a first reception confirmation value generated by the PINE;
wherein the apparatus further includes:
a fourth determination module configured to determine that the PINE correctly receives the operator credential when the first reception confirmation value and the second reception confirmation value are the same.

In some embodiments, the fifth receiving module 510 is configured to receive from the second network element a notification that the operator credential is correctly received.

In some embodiments, the apparatus further includes:
a check module configured to check whether a PEGC connected to the PINE is legitimate before configuring the operator credential for the PINE;
wherein the configuration module 520 is further configured to configure the operator credential for the PINE according to the fourth request when the PEGC is legitimate.

An embodiment of the present disclosure provides a communication device, including:
a memory for storing processor-executable instructions; and
a processor connected with the memory;
where the processor is configured to implement the information processing method provided by any of the aforementioned technical solutions.

The processor may include various types of storage medium, which are non-transitory computer storage medium that can continue to memorize information stored thereon after the communication device is powered off.

Here, the communication device includes: a PINE or a network element, and the network element can be any one of the first network element to the third network element mentioned above.

The processor may be connected to the memory via a bus or the like, and is configured to read an executable program stored in the memory, for example, at least one of the methods shown in FIG. 2 to FIG. 14.

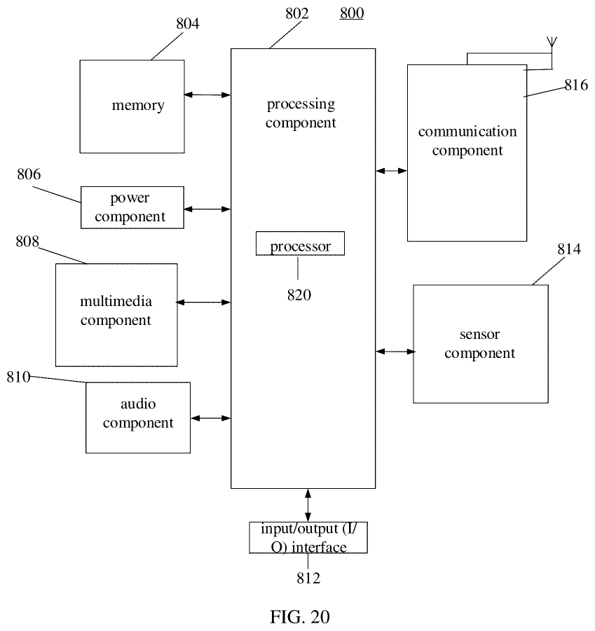

FIG. 20 is a block diagram of a communication device 800 according to an example embodiment. For example, the communication device 800 may be the PINE and/or PEGC described above, and specifically the communication device 800 may be a mobile phone, a computer, digital broadcast user equipment, a messaging device, a gaming console, a tablet, a medical device, exercise equipment, a personal digital assistant, and the like.

Referring to FIG. 20, the communication device 800 may include one or more of the following components: a processing component 801, a memory 804, a power component 806, a multimedia component 808, an audio component 810, an input/output (I/O) interface 812, a sensor component 814, and a communication component 816.

The processing component 802 typically controls overall operations of the communication device 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the communication device 800. Examples of such data include instructions for any applications or methods operated on the communication device 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the communication device 800. The power component 800 may include a power management system, one or more power sources, and any other components associated with the generation, management, and distribution of power in the communication device 800.

The multimedia component 808 includes a screen providing an output interface between the communication device 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the communication device 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (“MIC”) configured to receive an external audio signal when the communication device 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the communication device 800. For instance, the sensor component 814 may detect an open/closed status of the communication device 800, relative positioning of components, e.g., the display and the keypad, of the communication device 800, a change in position of the communication device 800 or a component of the communication device 800, a presence or absence of user contact with the communication device 800, an orientation or an acceleration/deceleration of the communication device 800, and a change in temperature of the communication device 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the communication device 800 and other devices. The communication device 800 can access a wireless network based on a communication standard, such as WiFi, 2G, or 3G, or a combination thereof. In one example embodiment, the communication component 816 receives a broadcast signal or broadcast associated information from an external broadcast management system via a broadcast channel. In one example embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In example embodiments, the communication device 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In example embodiments, there is also provided a non-transitory computer-readable storage medium including instructions, such as the memory 804 including instructions executable by the processor 820 in the communication device 800, for performing the above-described methods. For example, the non-transitory computer-readable storage medium may be a ROM, a Random Access Memory (RAM), a CD-ROM, a magnetic tape, a floppy disc, an optical data storage device, and the like.

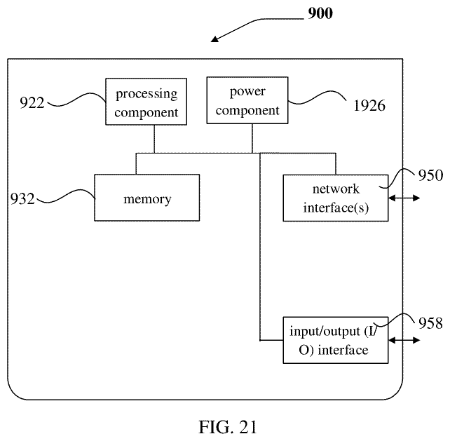

As shown in FIG. 21, an embodiment of the present disclosure shows a structure of a network element. For example, a network element 900 may be provided as a network side device. The network element may be the first network element, the second network element or the third network element described above.

Referring to FIG. 21, the network element 900 includes a processing component 922 that further includes one or more processors, and memory resources represented by a memory 932 for storing instructions executable by the processing component 922, such as application programs. The application programs stored in the memory 932 may include one or more modules each corresponding to a set of instructions. Further, the processing component 922 is configured to execute the instructions to perform any of the above described methods which are applied at the access device, for example, the methods shown in FIG. 2 to FIG. 14.

The network element 900 may also include a power component 926 configured to perform power management of the network element 900, wired or wireless network interface(s) 950 configured to connect the network element 900 to a network, and an input/output (I/O) interface 958. The network element 900 may operate based on an operating system stored in the memory 932, such as Windows Server™, Mac OS X™, Unix™, Linux™, FreeBSD™, or the like.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

1. An information processing method, wherein the method is performed by a Personal IoT Network Element (PINE), and the method comprises:
sending a first request for applying for an operator credential to a Personal IoT Network (PIN) Element with Gateway Capability (PEGC) based on a preconfigured operator public key;
receiving a first response returned based on the first request; and
obtaining the operator credential carried in the first response based on the operator public key.

2. The method according to claim 1, wherein sending the first request for applying for the operator credential to the PEGC based on the preconfigured operator public key comprises:
encrypting a first random number and a first timestamp using the preconfigured operator public key to obtain encrypted information; and
sending the first request to the PEGC according to the encrypted information, a public key identifier of the operator public key and an identifier of the PINE.

3. The method according to claim 2, wherein the encrypted information further comprises: a second random number encrypted using the operator public key;
wherein sending the first request for applying for the operator credential to the PEGC based on the preconfigured operator public key, comprises:
performing integrity protection on the encrypted information, the public key identifier of the operator public key, an identifier of an integrity protection algorithm and the identifier of the PINE using the second random number to generate a message authentication code; and according to the encrypted information, the public key identifier of the operator public key, the identifier of the PINE and the message authentication code, sending the first request to the PEGC.

4. The method according to claim 2, wherein the first response carries a digital signature;
wherein obtaining the operator credential carried in the first response based on the operator public key comprises:
performing signature verification on the first response based on the operator public key and the digital signature; and
after the first response passes the signature verification, decrypting an encrypted credential carried in the first response using the first random number to obtain the operator credential.

5. The method according to claim 4, wherein the first response further comprises a second timestamp;
wherein the method further comprises:
determining whether the first response is subject to a replay attack according to the second timestamp;
wherein decrypting the encrypted credential carried in the first response using the first random number to obtain the operator credential after the first response passes the signature verification comprises:
when the first response passes the signature verification and it is determined that the first response is not subject to the replay attack, decrypting the encrypted credential using the first random number to obtain the operator credential for the PINE.

6. The method according to claim 1, further comprising:
when the first response comprises a credential confirmation indicator and the operator credential is correctly received, generating, using the operator public key, a first reception confirmation value indicating that the operator credential is correctly received; and
sending the first reception confirmation value to the PEGC.

7. The method according to claim 6, wherein generating, using the operator public key, the first reception confirmation value indicating that the operator credential is correctly received comprises:
according to the operator public key, the operator credential and an identifier of the PINE, generating the first reception confirmation value.

8. The method according to claim 6, wherein sending the first reception confirmation value to the PEGC comprises:
sending the first receipt confirmation value and the credential confirmation indicator to the PEGC.

9.-11. (canceled)

12. An information processing method, wherein the method is performed by a first network element, and the method comprises:
receiving a second request sent by a Personal IoT Network (PIN) Element with Gateway Capability (PEGC), wherein the second request is sent based on a first request, and the first request is a request which is sent by a Personal IoT Network Element (PINE) based on a preconfigured operator public key and is used for applying for an operator credential;
sending a third request to a second network element according to the second request;
receiving a third response returned based on the third request; and
sending a second response to the PEGC according to the third response.

13. The method according to claim 12, further comprising:
receiving a first reception confirmation value sent by the PEGC, wherein the first reception confirmation value is generated by the PINE based on an operator public key, an encrypted credential and an identifier of the PINE after the PINE correctly receives the operator credential; and
sending the first reception confirmation value to the second network element.

14. An information processing method, wherein the method is performed by a second network element, and the method comprises:
receiving a third request;
determining whether to configure an operator credential for a Personal IoT Network Element (PINE) based on a result of processing the third request using an operator private key;
when it is determined to configure the operator credential for the PINE, sending a fourth request to a third network element;
receiving the operator credential returned based on the fourth request;
performing security processing on the operator credential using the operator private key to obtain the operator credential after security processing; and
sending a third response to a first network element by carrying the operator credential after security processing in the third response.

15. The method according to claim 14, wherein the determining whether to configure the operator credential for the PINE based on the result of processing the third request using the operator private key comprises:
determining the operator private key according to a public key identifier of an operator public key carried in the third request;
decrypting encrypted information carried in the third request using the operator private key to obtain a first random number and a first timestamp;
determining whether the encrypted information is subject to a replay attack according to the first random number and the first timestamp; and
when the encrypted information is not subject to the replay attack, determining to configure the operator credential for the PINE.

16. The method according to claim 15, wherein the encrypted information further comprises a second random number, and the third request further comprises a message authentication code,
wherein the method further comprises:
performing integrity protection verification on the encrypted information, the public key identifier, an identifier of an integrity protection algorithm, and an identifier of the PINE according to the message authentication code and the second random number;
wherein determining to configure the operator credential for the PINE when the encrypted information is not subject to the replay attack comprises:
when the encrypted information is not subject to the replay attack and the integrity protection verification is passed, determining to configure the operator credential for the PINE.

17. The method according to claim 14, wherein performing the security processing on the operator credential using the operator private key to obtain the operator credential after security processing comprises:
encrypting the operator credential according to a first random number comprised in encrypted information to obtain an encrypted credential; and
signing, using the operator private key, the encrypted credential and a second timestamp for generation of the encrypted credential to obtain a digital signature.

18. The method according to claim 17, wherein encrypting the operator credential according to the first random number comprised in the encrypted information to obtain the encrypted credential comprises:
performing bitwise XOR on the first random number and the operator credential to obtain the encrypted credential.

19. (canceled)

20. The method according to claim 14, further comprising:
sending the operator credential after security processing to the third network element;
wherein sending the third response to the first network element by carrying the operator credential after security processing in the third response comprises:
receiving a configuration result provided by the third network element based on the operator credential after the security processing; and
sending the third response comprising the configuration result to the first network element.

21. (canceled)

22. The method according to claim 14, further comprising:
generating a second reception confirmation value;
receiving a first reception confirmation value sent by the first network element;
when the second reception confirmation value is the same as the first reception confirmation value, determining that the PINE correctly receives the operator credential; and
sending, to the third network element, a notification that the operator credential is correctly received, or
wherein the method further comprises:
generating the second reception confirmation value, and providing the second reception confirmation value along with the operator credential after security processing to the third network element;
receiving the first reception confirmation value sent by the first network element; and
sending the first reception confirmation value to the third network element, wherein the first reception confirmation value is used for the third network element to determine, based on the second reception confirmation value, whether the PINE has correctly received the operator credential.

23.-58. (canceled)

59. A communication device, comprising:
a processor;
a transceiver; and
a memory storing an executable program executable by the processor,
wherein the processor is configured to perform the method according to claim 1.

60. (canceled)

61. A communication device, comprising:
a processor;
a transceiver; and
a memory storing an executable program executable by the processor,
wherein the processor is configured to perform the method according to claim 12.

62. A communication device, comprising:
a processor;
a transceiver; and
a memory storing an executable program executable by the processor,
wherein the processor is configured to perform the method according to claim 14.
